(19) United States
(12) Patent Application Publication
(10) Pub. No.: US 2005/0149375 A1
(43) Pub. Date: Jul. 7, 2005

(54) Systems and methods for handling and managing workflows

(76) Inventor: Wolfgang Marcus Wefers, Heidelberg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/002,787

(22) Filed: Dec. 3, 2004

Related U.S. Application Data
(60) Provisional application No. 60/526,962, filed on Dec. 5, 2003.
(60) Provisional application No. 60/527,000, filed on Dec. 5, 2003.

(51) Int. Cl. G06F 17/60

(52) U.S. Cl. 705/9

(57) ABSTRACT

Methods and systems are provided for handling and managing workflows in an organization. In accordance with one aspect, such methods and systems may perform a process including assigning roles to persons in the organization, each role comprising one or more responsibilities for each person assigned to a role. The process may further include defining and scheduling workflows for managing internal controls of the organization, each workflow comprising a plurality of tasks to be performed by persons in the organization according to their assigned roles. Additionally, the process may include communicating required tasks of each workflow to persons in the organization through respective dedicated interfaces.

### CROSS-REFERENCE TO RELATED APPLICATION(S)

This application claims the benefit of U.S. Provisional Patent Application No. 60/526,962 entitled, “Systems and Methods for Handling and Managing Workflows,” filed Dec. 5, 2003, and U.S. Provisional Patent Application No. 60/537,000 entitled, “Systems and Methods for Assigning Task-Oriented Roles to Users,” filed Dec. 5, 2003, the disclosures of which are expressly incorporated herein by reference to their entirety.

### BACKGROUND

1. Field of the Invention

The present invention generally relates to the field of data processing. More particularly, the present invention relates to methods and systems for handling and managing workflows in organizations, such as business organizations and other entities.

2. Background Information

The Sarbanes-Oxley Act (SOA) was enacted by the United States Congress on Jul. 30, 2002 and applies to all companies registered with the Securities and. Exchange Commission (SEC). An SEC registered company is one that is traded on a stock market or exchange in the United States (e.g., NYSE, Nasdaq, etc.). The SOA establishes heightened requirements in the area of corporate governance, financial disclosures, and accountability for fraud. Specifically, it requires organizations to periodically evaluate and certify/report as to the effectiveness of their internal control of business practices. Other countries are expected to determine the need for and possibly also establish guidance or requirements (e.g., the German government has issued a 10-Point Plan on corporate governance standards in February 2003).

The SEC defines internal control (applying a framework known as the Committee of Sponsoring Organization (COSO)) as a process that is carried out by an entity's board of directors, management and other personnel, and designed to provide reasonable assurance regarding the achievement of control objectives in certain categories. These categories include, for example, effectiveness and efficiency of operations, reliability of financial reporting, and compliance with applicable laws and regulations.

Under Section 404 of the SOA, an organization's management must annually assess its company's internal controls. In particular, the management must provide an internal control report that states management's responsibility for establishing and maintaining adequate internal control structure and procedures for financial reporting. Further, management must assess the effectiveness of their organization's internal control structure and the current procedures for financial reporting. Also, the assessment must be attested by an external auditor.

A Section 404 evaluation should: (a) identify any material weakness in a company's current disclosure controls and procedures; (b) identify any deficiency that would impact the company's ability to collect, analyze and disclose material information; and (c) disclose any corrective actions taken or to be taken by the company to improve its disclosure controls and procedures.

In addition, Section 302 of the SOA requires a CEO/CFO of a business organization to certify quarterly and annually that: (a) an SEC report being filed has been reviewed; (b) the report does not contain any untrue statements or omit any material facts necessary to make the statements made not misleading; (c) all financial statements fairly present, in all material respects, the financial position, results of operations and cash flows; (d) the CEO/CFO is responsible for and has designed, established, and maintained Disclosure Controls & Procedures (“DC&P”), as well as evaluated and reported on the effectiveness of those controls and procedures within 90 days of the report filing date; (e) any deficiencies and material weaknesses in internal control and any fraud (material or not) involving anyone with a significant role in internal control have been disclosed to an audit committee and auditors; and (f) significant changes in internal control affecting controls for periods beyond review have been reported, including any corrective actions with regard to significant deficiencies and material weaknesses in internal control.

Past attempts to facilitate the management of internal controls have been ineffective or too costly. Such solutions are performed manually, documented through paper, and/or attempted through various software applications (electronic spreadsheets, etc.). For large organizations and all companies faced with the increasing demarids for internal control management (including that required by the SOA in the U.S.), improved solutions are required. For example, there is a need for improved systems and methods for handling and managing workflows in an organization, such as workflows among a plurality of different persons in an organization, wherein each person is assigned specific roles and/or tasks.

### SUMMARY

Methods and systems consistent with embodiments of the present invention provide processes for handling and managing workflows in an organization. Such methods and systems may be computerized or implemented with software, as further disclosed herein.

In accordance with one aspect, methods and systems may perform a process including assigning roles to persons in the organization, each role comprising one or more responsibilities for each person assigned to a role. The process may further include defining and scheduling workflows for managing internal controls of the organization, each workflow comprising a plurality of tasks to be performed by persons in the organization according to their assigned roles. Additionally, the process may include communicating required tasks of each workflow to persons in the organization through respective dedicated interfaces.

Consistent with another aspect of the present invention, a system may be provided for managing workflows in an organization in which persons are assigned roles, each role comprising one or more responsibilities for each person assigned to a role. The system may include a network of computers associated with the organization, whereby at least one of the computers executes software that provides dedicated user interfaces for defining and scheduling workflows to manage internal controls of the organization, each workflow comprising a plurality of tasks to be performed by persons in the organization according to their assigned roles. Further, the software may provide dedicated user interfaces for communicating tasks of each workflow to the persons in the organization.

In another aspect of the invention, a computer-readable medium is provided that includes instructions for performing, when executed by a processor, a process for managing workflows in an organization. The process may include assigning roles to persons in the organization, each role comprising one or more responsibilities for each person assigned to a role. The process may also include defining and scheduling workflows for managing internal controls of the organization, each workflow comprising a plurality of tasks to be performed by persons in the organization according to their assigned roles. Also, the process includes communicating required tasks of each workflow to persons in the organization through respective dedicated interfaces for each person.

In another aspect of the invention, a system may be provided for managing workflows in an organization that includes a display system for displaying content and a computer system. The computer system may be configured to execute software to present a user interface on the display. The user interface may include information reflecting one or more tasks to be performed by a person in the organization. The one or more tasks may be included in a workflow for managing internal controls of the organization and are to be performed by the person based on an assigned role of the person in the organization.

The foregoing background and summary are not intended to be comprehensive, but instead serve to help artisans of ordinary skill understand the following implementations and embodiments consistent with the invention set forth in the appended claims. In addition, the foregoing background and summary are not intended to provide any limitations or restrictions on the claimed invention.

### BRIEF DESCRIPTION OF THE DRAWINGS

The accompanying drawings show features of implementations consistent with aspects related to the present invention and, together with the corresponding written description, help explain principles associated with the invention. In the drawings:

FIG. 1 is block diagram of an exemplary organization structure, consistent with certain aspects related to the present invention;

FIG. 2 illustrates a flowchart depicting an exemplary method for managing internal controls, consistent with certain aspects related to the present invention;

FIG. 3 illustrates a flowchart depicting an exemplary method for setting up the scope and project for managing internal controls, consistent with certain aspects related to the present invention;

FIG. 4 illustrates a block diagram of an exemplary organization hierarchy structure, consistent with certain aspects related to the present invention;

FIG. 5 illustrates a block diagram of an exemplary central business process catalog, consistent with certain aspects related to the present invention;

FIG. 6 illustrates a block diagram of exemplary relationships between business processes and financial statement accounts, consistent with certain aspects related to the present invention;

FIG. 7 illustrates a block diagram of an exemplary control objective and risk catalog, consistent with certain aspects related to the present invention;

FIG. 8 illustrates a block diagram of an exemplary control objective and risk catalog table, consistent with certain aspects related to the present invention;

FIG. 9 illustrates a block diagram of an exemplary business process assignment, consistent with certain aspects related to the present invention;

FIG. 10 illustrates a flowchart depicting an exemplary method for initial documentation of internal controls, consistent with certain aspects related to the present invention;

FIG. 11 illustrates a block diagram of exemplary business unit processes, consistent certain aspects related to the present invention;

FIG. 12 illustrates a block diagram of exemplary risk assignments, consistent certain aspects related to the present invention;

FIG. 13 illustrates a block diagram of an exemplary assignment of controls, consistent certain aspects related to the present invention;

FIG. 14 illustrates a block diagram of an exemplary screen shot and data structure of a To-Do List, consistent-certain aspects related to the present invention;

FIG. 15 illustrates a block diagram of an exemplary screen shot of a task assignment page, consistent certain aspects related to the present invention;

FIG. 16 illustrates a flowchart depicting an exemplary method for assessing and remediating internal controls, consistent with certain aspects related to the present invention;

FIGS. 17-21 illustrate block diagrams of exemplary interfaces and process flows for assessing and remediating a control design, consistent certain aspects related to the present invention;

FIGS. 22 and 23 illustrate block diagrams of exemplary interfaces and process flows for testing and remediating controls, consistent certain aspects related to the present invention;

FIG. 24 illustrates a block diagram of an exemplary organization hierarchy related to corresponding organization processes for managing internal controls, consistent certain aspects related to the present invention; and

FIG. 25 illustrates a block diagram of an exemplary system environment for implementing one or more features, consistent with aspects related to the present invention.

### DETAILED DESCRIPTION

The following description refers to the accompanying drawings, in which, in the absence of a contrary representation, the same numbers in different drawings represent similar elements. The implementations set forth in the following description do not represent all implementations or embodiments consistent with the claimed invention. Instead, they are merely some examples of systems and methods consistent with aspects of the invention. Other implementations may be used and structural and procedural changes may be made without departing from the scope of present invention.

Conceptual Overview

Systems and methods consistent with certain aspects related to the invention facilitate the handling and management of workflows within an organization. For example, systems and methods may be provided for managing a workflow among a plurality of different persons in an organization, wherein the execution of the workflow is dependent on the specific role(s) or task(s) assigned to each person. Consistent with certain aspects of the invention, such systems and methods may provide an easier way and/or more efficient approach toward the handling of workflows and tasks performed by various persons in an organization.

As used herein, the term “organization” encompasses any type of organization or entity, such as a large or publicly traded company, a business unit, an agency, a foundation, a non-profit organization, a governmental body, etc. Further, a “workflow” may comprise any set of tasks or activities to be performed by one or more persons in an organization. By way of example, the execution of a workflow may require the joint effort of a plurality of different persons in an organization, wherein each person has specific task(s) that they are responsible for handling or performing. The assignment of task(s) to a person may be dependent upon the role(s) that the person performs within the organization. Further, each workflow may require that certain tasks be performed in a predetermined order or sequence by the plurality of different persons.

The handling and management of workflows, in accordance with certain implementations or embodiments of the invention, may be performed for the purposes of, for example, internal management control. Internal management control may be performed consistent with local or national law (such as the SOA in the United States). Examples of workflows for internal management control include, for instance, assessment of control design, assessment of control efficiency, assessment of process design, and testing of control effectiveness.

In certain aspects of the invention, methods and system may set up a project for monitoring and assessment internal control in an organization. The monitoring and assessment may include establishing business processes and controls for performing one or more workflows by one or more persons in the organization. Further, methods and systems consistent with the present invention may enable selected persons to assess control designs, efficiencies and business process designs, as well as identify issues associated with internal controls for the organization. Remediation plans may be established, assessed and performed to address the identified issues. Additionally, these plans may be tested in order to identify additional issues and to determine whether a remediation plan effectively and efficiently provides internal control management. Once final analysis of the internal control procedures is performed, management reports may be generated that are used by management of the organization to conform to the standards set forth by internal or external organizational requirements.

In accordance with certain aspects of the present invention, methods and systems are provided for managing workflows in an organization. Using software executed processes, users may automatically inform one another when a subsequent person needs to be involved and perform specific tasks in a workflow. The workflow may involve many persons that belong to different roles that must interact with each other. Systems and methods may enable, consistent with the invention, persons to know from each other what tasks have been performed and when a subsequent activity or task is required or when a first person can continue their tasks in a workflow.

Embodiments of the present invention enable an organization to schedule workflows based on organization level criteria. For example, governmental standards-for internal controls may require that an organization assess its internal controls once a year. As such, the corporate level workflows scheduled by an authorized user may designate to managers in lower level organization units to perform internal control management with at least this frequency. The managers, however, may determine that their workflows and internal control tasks may require more frequent execution. Accordingly, organization unit level, or perhaps lower level entities, may schedule workflows in a manner that is different than other organization levels.

For purposes of illustration, exemplary implementations of the invention will be described in which task-orientated roles are assigned to persons as part of the functionality of software executed processes. In these examples, it is assumed that a large number of different users and roles exist. Methods and systems consistent with aspects of the present invention support the handling of roles and system authorizations in a user-friendly way.

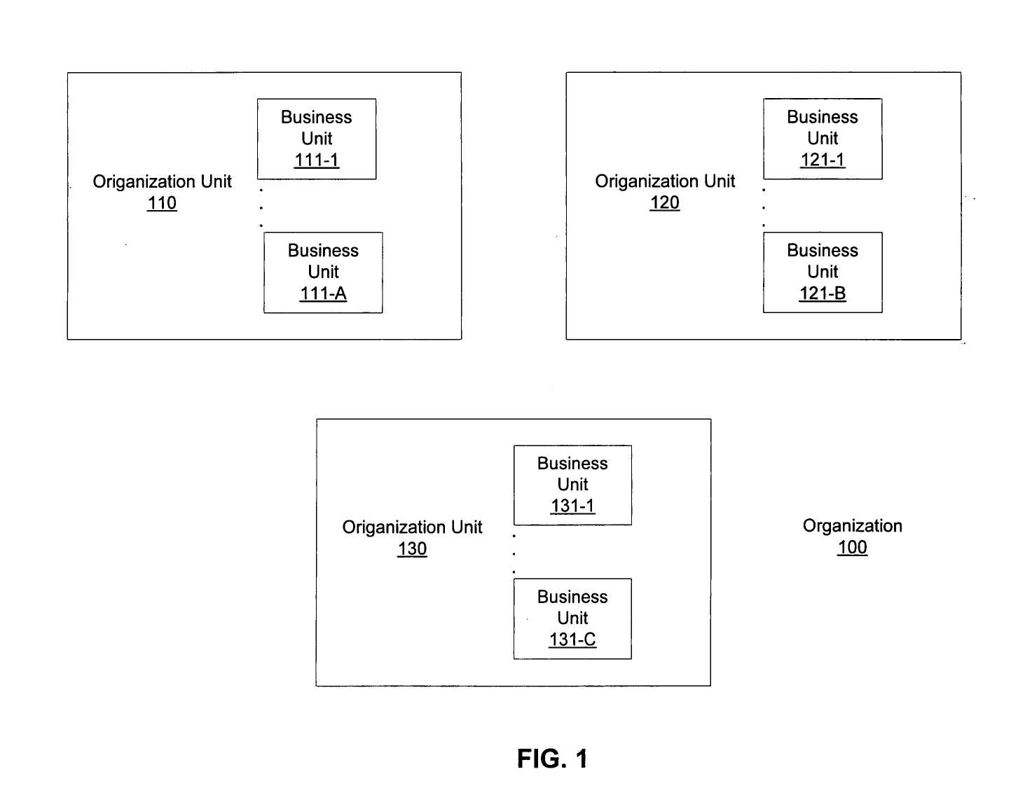

FIG. 1 illustrates a block diagram of an exemplary organization 100, consistent with certain aspects of the present invention may be implemented. As shown, organization 100 may include one or more Organization Units (OUs) 110, 120, and 130. An organization unit may be, for example, a legal entity, a geography, or a functional business entity associated with organization 100, such as a domestic or foreign subsidiary unit of organization 100. Further, an OU may be a shared type unit that includes information and provides resources for other OUs within organization 100. For instance, OU 110 may be a shared services OU that provides Information Technology (IT) or Human Resource (HR) services for all or some of the OUs in organization 100.

Each organization unit 110, 120, and 130 may include one or more Business Units (BUs) that are sub-entities associated with a respective organization unit. For example, a business unit may be a sales department, a marketing department, etc. As shown in the example of FIG. 1, OU 110 includes BUs 111-1 and 111-A, OU 120 includes BUs 121-1 to 121-B, and OU 130 includes BUs 131-1 to 131-C, where A, B, and C are integers greater than zero. Although FIG. 1 shows certain numbers of OUs and BUs, any number of organization units and corresponding business units may be included in organization 100.

Organization 100 may implement internal controls to meet governmental or internal reporting requirements, consistent with certain aspects of the present invention. Accordingly, organization 100 may implement one or more reporting mechanisms that allow workflows for internal management control to be managed and performed.

Workflows may be associated with any type of task or activities related to operation of organization 100. For exemplary purposes only, aspects of the present invention are described in relation to managing internal controls within organization 100. Methods and systems of the present invention, however, are not limited to these exemplary types of workflows and processes.

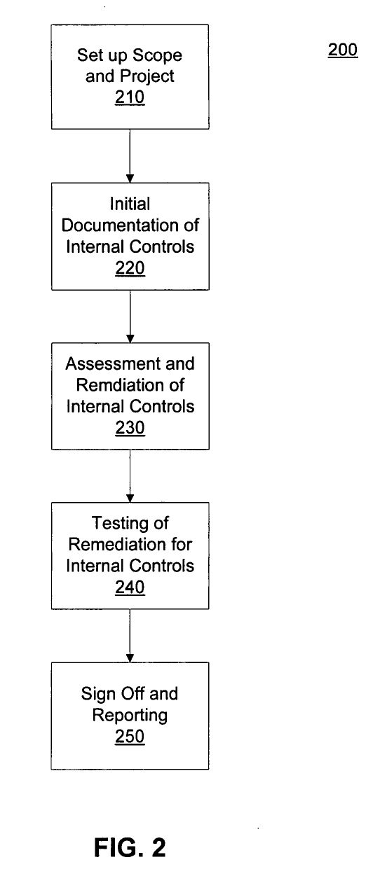

FIG. 2 illustrates an exemplary general process flow 200 that may be implemented by organization 100 to manage internal controls of organization 100. As shown in the example of FIG. 2, methods and systems may identify and set up a scope and project structure for managing these controls (Step 210). Process flow 200 may also include performing an initial documentation of internal controls for organization 100 (Step 220). The internal controls may then be assessed, and based on the assessment, remediation of the internal controls may be created (Step 230). Once created, the remediation of the internal controls are tested (Step 240) and once validated, the internal controls may be signed off by authorized personnel and any required reporting may be performed (Step 250). Consistent with an aspect of the invention, reporting may include issuing final reports that meet the requirements of, for example, any applicable governmental and/or organizational reporting standards.

The foregoing discussion is intended to introduce and provide initial clarity for some of the aspects associated with the present invention. Further details of the above-mentioned functionality and embodiments as well as additional aspects, features, and embodiments of the present invention are described below.

Set Up Scope and Project

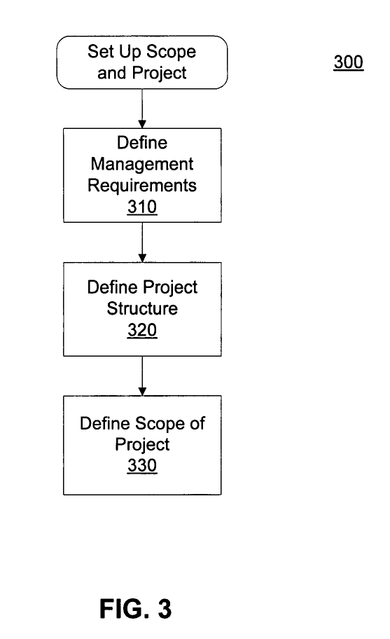

FIG. 3 illustrates a flowchart depicting an exemplary method 300 for setting up the scope and project for managing internal controls, consistent with certain aspects related to the present invention. As shown in FIG. 3, setting up the scope and project may include defining one or more management requirements for organizational internal controls (Step 310). Further, the structure and the scope of the internal control project may be defined (Steps 320 and 330, respectively). Steps 310 through 330 may be performed manually by one or more persons of an organization, automatically through software executed by one or more computers, or through a combination of manual and automated processes assisted by software executed by one or more computers, such as user interfaces generated to assist a person in performing one or more of the steps in FIG. 3.

Defining Management Requirements

Defining management requirements (e.g., Step 310) may include setting thresholds and criteria for monitored data and business processes within an organization (e.g., organization 100). As used herein, the term “business process” refers to any related group of activities that produce an output associated with a value-related goal. A business process “activity” may include any operation, procedure, task, process step, transaction, initiative, and/or sequence of actions performed in order to achieve the overall business process goal. Business process activities may be computer-performed and/or performed by one or more individuals (e.g., executives, workforce, customers, etc.). Business processes may be associated with one or more business units and/or organization units. A business process may be implemented either within a single business unit and/or organization unit or across several business and/or-organization units.

Defining management requirements may also include identifying and defining roll-up processes for management sign-off. This process may include identifying-relationships between management and workflows within an organization to define those business processes and workflows that require validation and the individuals authorized to validate them. Further, methods and systems related to the present invention may establish a level of documentation detail required for each business process and final report that is created.

Defining Project Structure

Setting up the scope and project may also include defining the project structure (e.g., Step 320). Defining the project structure may involve defining roles and responsibilities of individuals and/or groups of individuals associated with the organization. Roles and responsibilities may include tasks that are to be performed by an individual or group of individuals (e.g. committee) associated with management of internal controls for the organization. For example, a CEO of an organization may be assigned the role of signing-off corporate level reports, such as those being provided to a governmental entity as a representation of an organization's management of internal control. Further as an example, an organization unit manager may have a role of assigning organization unit and business process group owners and signing-off organization unit level reports, such as those reports that are provided to the CEO as a basis for forming the corporate level report; Exemplary embodiments for assigning roles and responsibilities which may be incorporated into implementations of the present invention are disclosed in U.S. patent application Ser. No. ______ (Attorney Docket no. 07781.0135-00), entitled “Systems and Methods for Assigning Task-Oriented Roles to Users,” which was filed on ______, and claims the benefit of U.S. Provisional Application No. 60/527,000 filed Dec. 5, 2003, the disclosures of which are hereby incorporated herein by reference in their entireties.

Defining Scope of Project

Setting up-the scope and project may further include defining the scope of the internal control project (e.g., Step 330). Defining the scope of the project may involve defining the scope at various levels associated with the organization, such as at organization and organizational unit levels. For instance, methods and systems consistent with certain aspects related to the present invention may identify organization units and business processes to be included in the internal control management of an organization. Further, these methods and systems may identify the process steps associated with each of the business processes.

In one aspect of the invention, defining the scope of the project may include creating an organization hierarchy of the organization. This process may be; customized by a user implementing methods and systems of the present invention, or it may be automatically performed by one or more software processes executing in a processing system. For example, the organization hierarch may be manually and/or automatically created from an organization's human resource organization files.

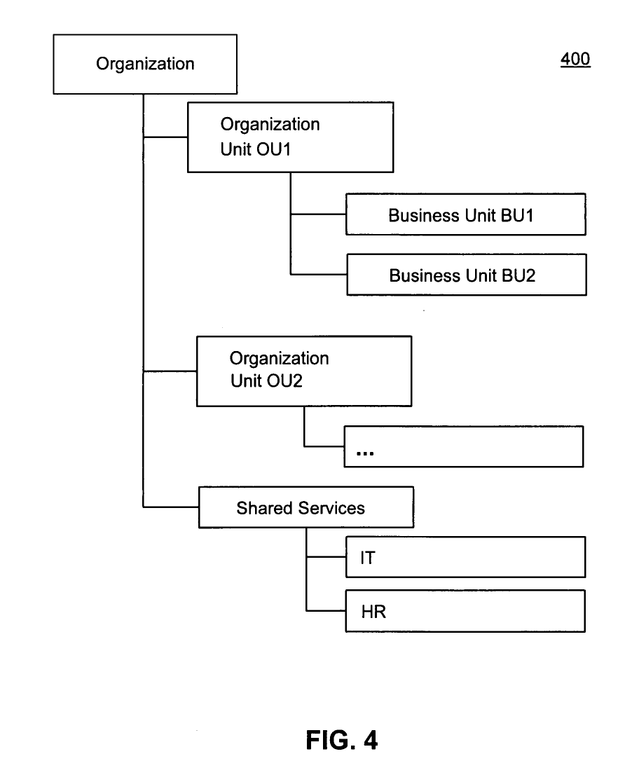

For purposes of illustration, FIG. 4 shows a block diagram of an exemplary organization hierarchy 400. The exemplary hierarchy of FIG. 4 may be created by methods and systems consistent with aspects of the present invention. Hierarchy 400 is illustrative of certain aspects of the present invention and is not intended to be limiting. That is, methods and system of the present invention may create any form of organization hierarchy based on the structure of an organization or as defined by a user or software process.

Defining the scope of the project may also include creating a central business process hierarchy. A business process hierarchy is a central catalog of business processes for an organization that are defined without details of any process steps. In one aspect, individuals or software processes associated with one or more organization units and business units of an organization may be assigned the task of defining the business process hierarchy. The business process hierarchy may include business process groups that are a set of business processes, such as a sales business process group.

In one aspect, methods and systems may include in the business process hierarchy only those business processes that have a material impact on financial reporting or disclosure controls and procedures associated with one or more governmental requirements, such as Sections 404 and 302 of the SOA, respectively. Such business processes may be identified from a group of business processes associated with the organization and added to the business process hierarchy. Identifying relevant business processes maybe performed by a user and/or a software executed process configured to filter specific business processes based on stored information associated with the governmental requirements and data structures reflecting the business process groups.

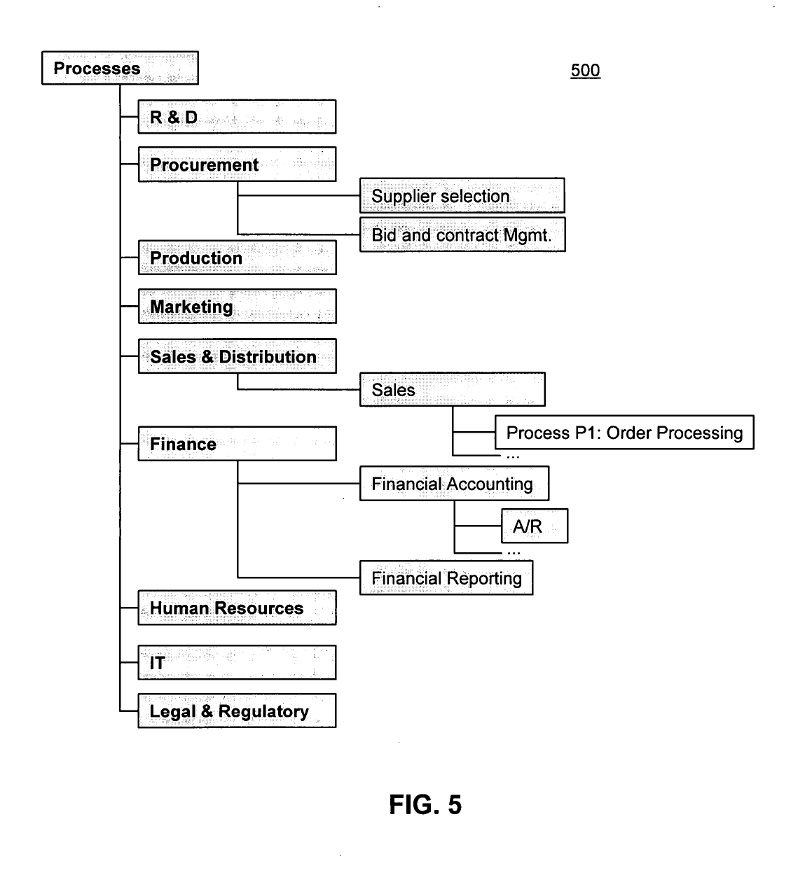

For purposes of illustration, FIG. 5 shows a block diagram of an exemplary central business process catalog 500. Catalog 500 may be for a specific organization and include those business processes (e.g., “Process P1: Order Processing”) that may influence financial reporting and/or disclosure controls for that organization.

Once a central business process catalog is created, the impact of each of the catalog's business processes on any organization financial accounts is determined. In one aspect, business processes within the central catalog are linked to relevant financial statement accounts associated with financial transactions of the organization. These statements may be stored as data structures in a computer-readable medium that are analyzed by a software process or may be paper-based documents that are reviewed by a user. Based on one or more rules that may be defined as software code or a user-based knowledge base, each business process in the central catalog may be linked to those organizational financial accounts that are affected by the respective business process. For example, a user may be presented with one or more user interfaces that provide a list of business processes included in a defined central business process catalog and a list of financial statement accounts that may be assigned to a business process in the catalog. In one embodiment, methods and systems of the present invention may allow the user to select or de-select one or more of the financial account statements while viewing a selected business process within the catalog. Thus, a user may leverage these interfaces to define the relationships between business processes and financial statement accounts for an organization.

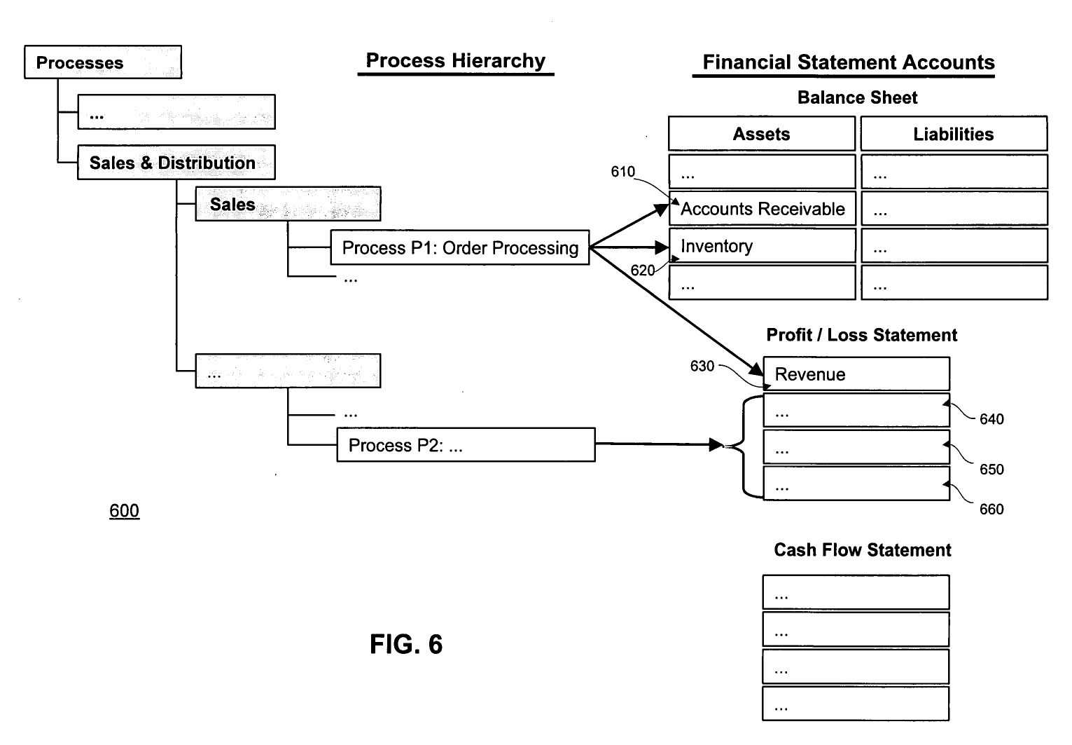

To further illustrate this aspect of the invention, FIG. 6 shows a block diagram 600 of exemplary relationships between business processes in a central catalog and financial statement accounts associated with an organization. As shown, FIG. 6 shows a business process “Process P1: Order-Processing” having a relationship with financial statement accounts 610, 620, and 630, labeled “Accounts Receivable,” “Inventory,” and “Revenue,” respectively. Further, another business process “Process P2:” is shown having a relationship with financial statement accounts 640, 650, and 660, under a profit/loss financial account statement. Diagram 600 is exemplary and not intended to limit any aspects of the present invention to particular business processes and/or financial statement accounts. Methods and systems consistent with the present invention may identify and define any number of relationships between any number of business processes and financial statement accounts.

In one embodiment, defining the scope of the project may include defining control objectives and corresponding risks. A control objective may be a statement or idea that captures the purpose of one or more controls within a process. A risk may be a potential event that adversely impacts a desired outcome of one or more control objectives. A control may be a procedure implemented by an organization to facilitate a particular business process. For example, a control may be a procedure that limits access to selected documentation and/or systems to authorized personnel. Another exemplary control may be a requirement that an authorized individual (e.g., a manager) approve of changes to business documents, such as a sales order document.

Any type of control may be implemented, consistent with by aspects of the present invention, that allow an organization to manage business transactions internal and external to an organization. Further, methods and systems consistent with the present invention may define one or more control objectives for each business process in the central catalog. Further, each control objective may be categorized in a predefined category, such as a financial, operational, and compliance related category.

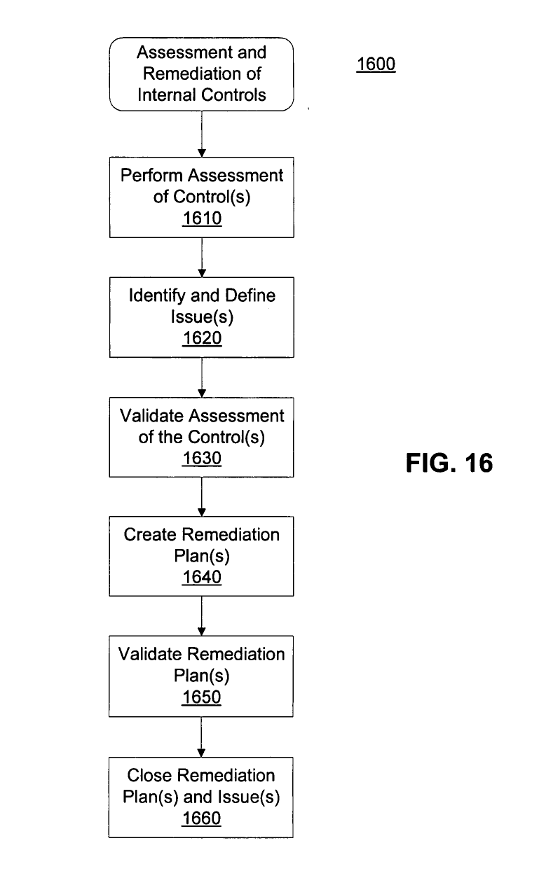

Additionally, controls may be grouped within management control groups that are used to aggregate the statuses of individual controls during issue creation, remediation, and reporting processes performed by methods and systems of the present invention and as described below in connection with, for example, FIG. 16. Exemplary management control groups may include a monitoring control group, an information and communication control group, a risk assessment control group, and a control environment control group. The control groups may be defined by a user or by software executed processes implemented by systems and methods of the present invention.

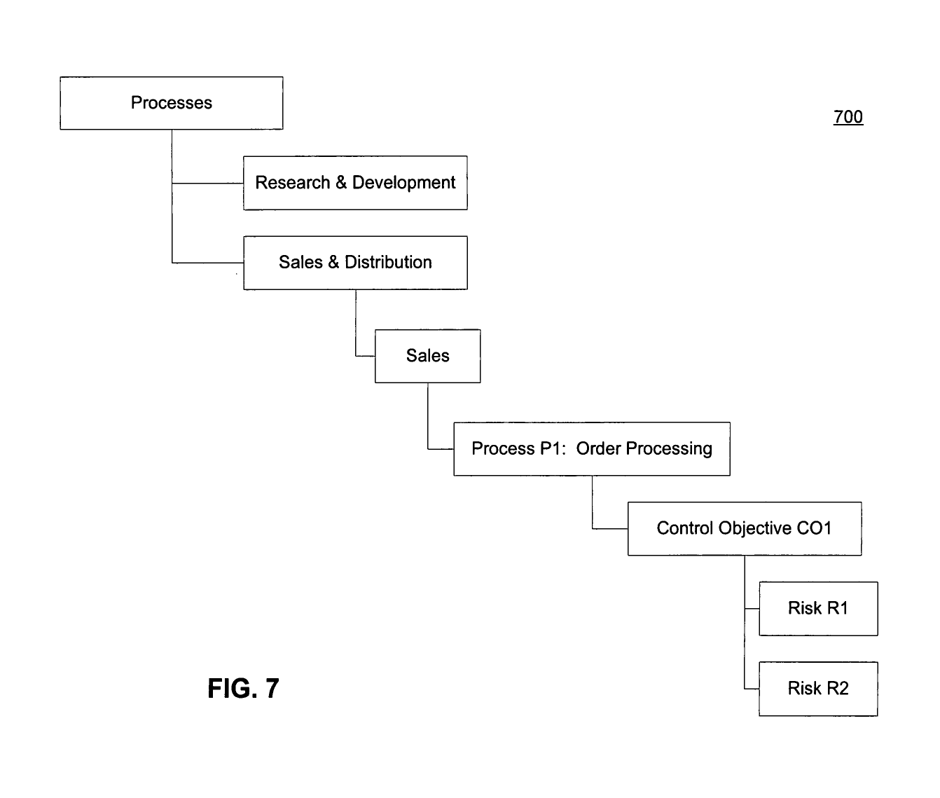

To further illustrate the process of defining control objectives and risks by organization and business unit using personal or software executed processes, reference will now be made to FIG. 7. In particular, FIG. 7 shows a block diagram of an exemplary control objective and risk catalog 700, consistent with aspects of the present invention. Catalog 700 may be stored as a data structure in a computer-readable medium and accessible by a user or a software executed process when performing internal control management processes, consistent with aspects of the present invention. A shown, control objective and risk catalog 700 includes a control object CO1 that is associated with a business process “Process P1: Order Processing.” Further, control objective CO1 is associated with risks R1 and R2.

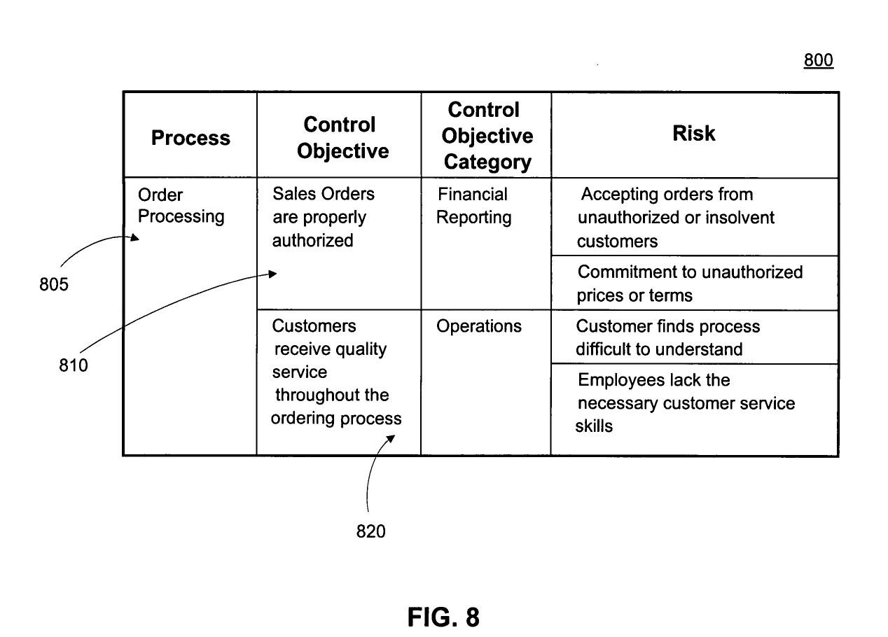

Consistent with aspects of the present invention, a user and/or software executed process may define and assign any type of risk and control objective to a predetermined control objective category. FIG. 8 shows a block diagram of an exemplary control objective and risk catalog table 800 corresponding to an exemplary business process “Order Processing” 805 that may be defined by methods and systems of the present invention. As shown, table 800 describes control objective categories and risks corresponding to control objectives 810 and 820 for the exemplary business process 805.

Defining the scope of the project may also include assigning one or more business processes to a business unit. In one aspect, business unit personnel and/or software executed process associated with the BU may select those business processes included in the central process catalog that are applicable and within a predetermined scope for the respective business unit. By assigning a business process to a BU, any relating business process groups may be automatically inherited from the central business process catalog.

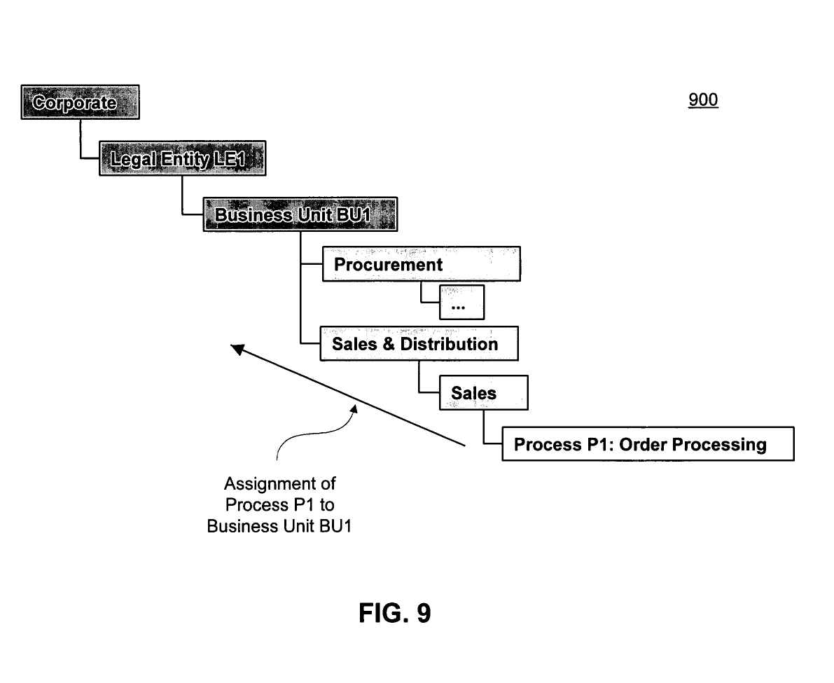

FIG. 9 shows a block diagram of a exemplary business process assignment 900 for an exemplary business unit, Business Unit BU1. As shown in FIG. 9, methods and systems consistent with aspects of the present invention may assign a business process (e.g., “Process P1: Order Processing”) to BU1. By doing so, a relating business process group (e.g., “Sales & Distribution”) is inherited, thus defining a hierarchical relationship between BU1 and the assigned business process.

As explained, one or more of the process steps involved in setting up the scope and project for management of internal controls may be performed through human interaction, software based executed processes, or a combination of both human and software executed processes. For example, an individual (e.g., manager of organization 100) may define the thresholds and roll up processes used in managing internal controls. Additionally, or alternatively, a software executed process may create an organization hierarchy based on data stored in a storage medium reflecting an organization's structure. The above examples are not intended to be limiting and any form of human and software and/or hardware collaboration may be implemented consistent with aspects of the present invention to perform the set up scope and project processes described above.

Initial Documentation of Internal Controls

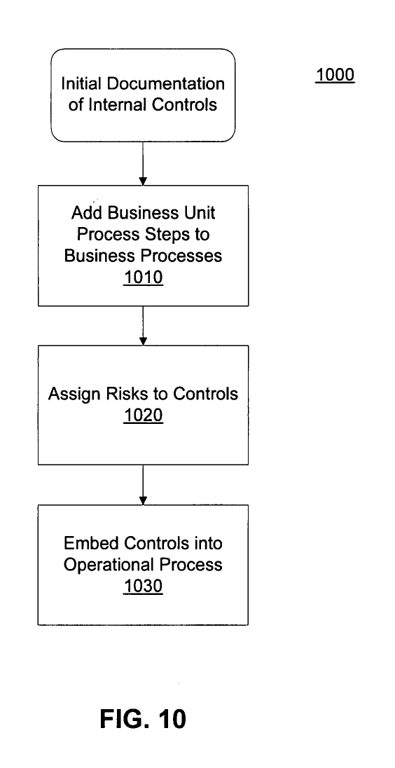

Referring back to FIG. 2, management of internal controls for an organization may include the initial documentation of internal controls (Step 220). FIG. 10 illustrates a flowchart of an exemplary initial documentation of internal controls process 1000 that may be performed, consistent with certain aspects of the present invention.

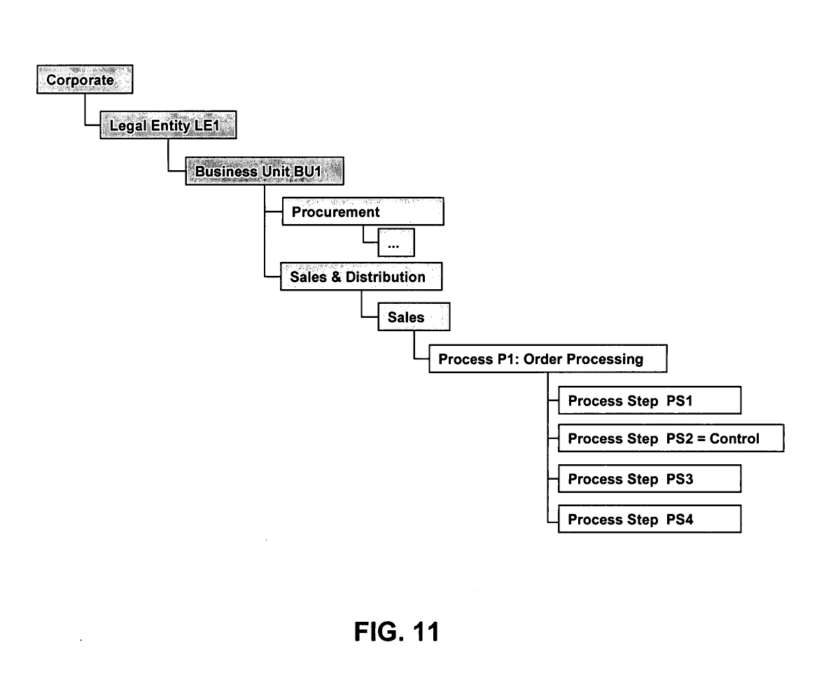

Initial documentation of internal controls may include adding business unit specific business process steps to each of the business processes assigned to a respective business unit (Step 1010). The business process steps may be created manually by individuals associated with a specific business unit or by software executed processes configured to create business unit specific process steps. By way of example, FIG. 11 shows a block diagram of exemplary BU-specific processes that may be added to the exemplary assigned business process “Process P1: Order Processing” described above.

In one aspect, each business process step may include one or more attributes that allow persons and/or computer executed software to control how each business process step is performed and managed. For example, each business process step may include an assigned role attribute that identifies an owner of the process step (i.e., an identified individual that is to perform the process step). Further, each business process step may include a control purpose attribute reflecting a control purpose for the respective process step. A frequency attribute may also be associated with a business process step that reflects how often the business process step is to be performed by the owner. Methods and systems consistent with aspects of the present invention may also include an automation attribute that determines whether a business process step is to be performed manually or automatically by software executed processes. The above business process step attributes are not intended to be limiting. Other attributes may be included in each of the process steps created and assigned to each business process for a particular business unit. Further, these attributes may be defined by a user through user interfaces generated by software executed by a computer system.

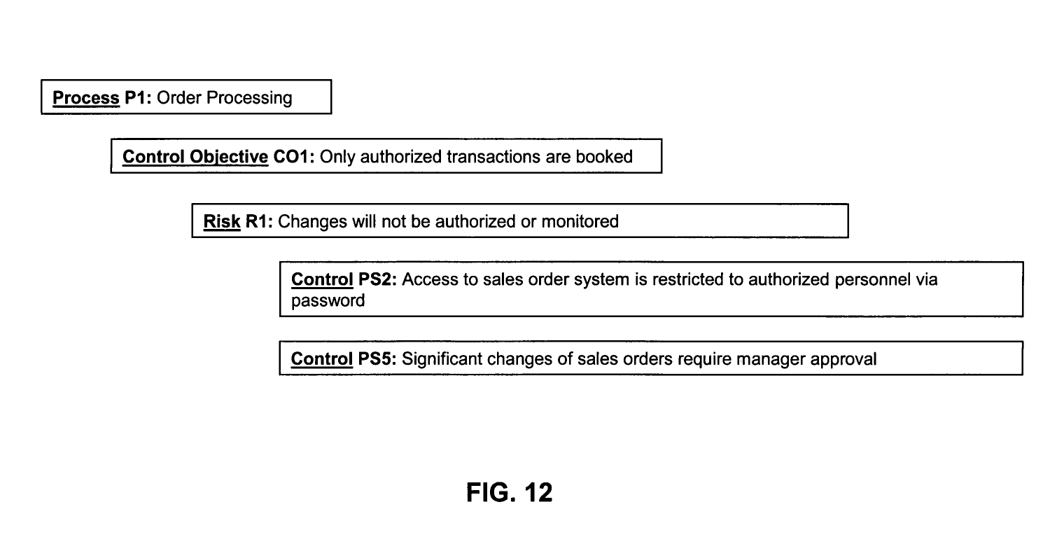

Referring back to FIG. 10, the initial documentation of internal controls may also include identifying risks related to the previously created control objectives. These risks may then be assigned to the controls reflected by the control objectives (e.g., Step 1020). To illustrate this aspect of the invention, FIG. 12 shows a block diagram of an exemplary risk assignment for a control objective CO1 associated with, the exemplary business process P1 “Order Processing.” As shown in this example, risk R1 (i.e., “changes will not be authorized or monitored”) is assigned to control objective CO1 (i.e., “Only authorized transactions are booked”). This risk is assigned: to controls PS2 (i.e., “access to sales order system is restricted to authorized personnel via password”) and PS5 (i.e., “significant changes of sales orders require manager approval”). Methods and systems consistent with the present invention may add additional internal controls to lower the risk associated with a control objective and business process. Risks may be assigned manually, automatically by software executed by a computer system, or by a combination of manual and computer executed processes.

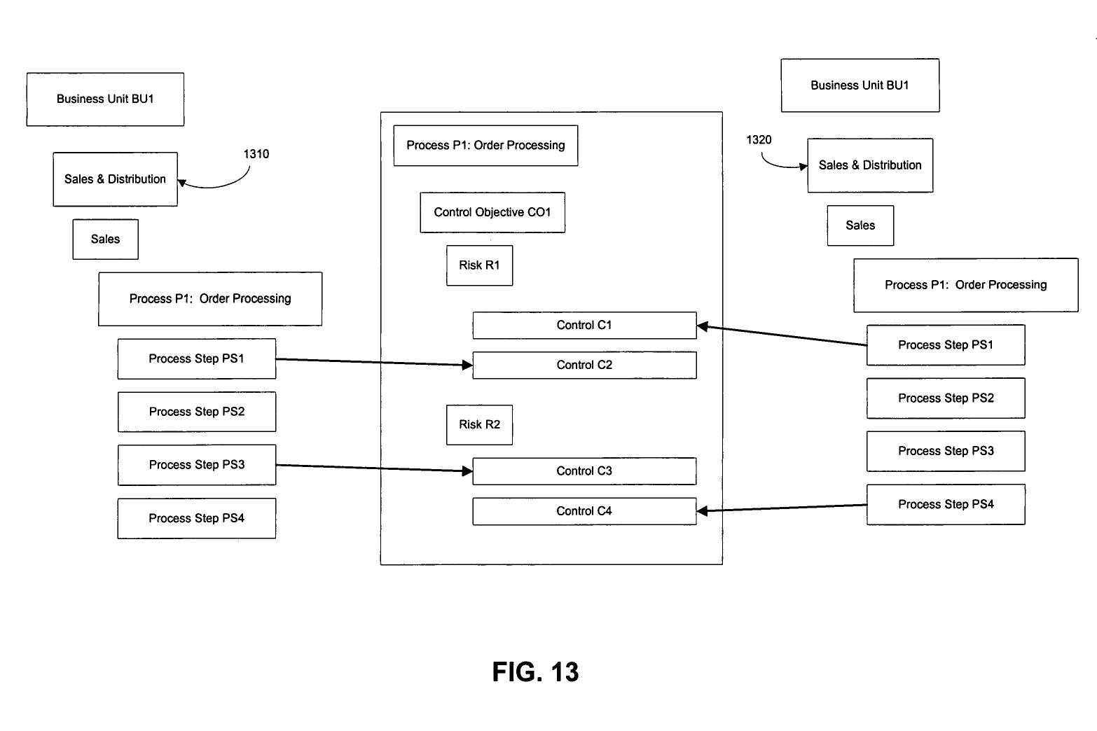

Once the risks are assigned, the controls for each control objective are embedded in the operational processes used in managing internal controls for the organization (Step 1030). Therefore, the controls included in a control objective that corresponds to other business processes are embedded with these other business processes via their process steps. For example, FIG. 13 shows a block diagram of the assignment of exemplary controls C1, C2, C3, and C4. As shown, controls C1-C4 associated with control objective CO1 are selectively assigned to business process steps PS1 to PS4 of business process P1 business process groups 1310 and 1320 (e.g., “Sales & Distribution” and “Finance”), respectively. Each control C1 to C4 is equivalent to a corresponding process step within a given business process. Thus, those controls that are aligned with a particular business process step (e.g., PS1) are embedded with that process step's parent business process (e.g., Process Step PS1 and Control C1 for business process P2 “Receivables”).

Workflows and Assessment and Remediation of Internal Controls

In accordance with certain aspects of the present invention, once the scope and project and the internal controls for are set up and/or documented for the management of internal controls, workflows may be scheduled and implemented for, these internal controls. As mentioned above, users in an organization may be assigned roles. Each role may have one or more tasks or activities associated with it. Accordingly, workflows are created and scheduled for each user based on their roles. In certain aspects, these workflows are used to assess internal controls and remediation plans associated with the controls (e.g., Step 230 of FIG. 2). Exemplary workflows that may be provided by methods and systems of the present invention include, an assessment of control design, assessment of control efficiency, assessment of process design, and testing of control effectiveness. Although other workflows may be created and implemented.

In accordance with one aspect of the invention, the handling and management of workflows may be facilitated through user interfaces or screens (e.g., GUIs) that provide information to each person of a business unit, including the tasks that are assigned to them, etc. Such screens may include a base web page, such as a Home Page, that may be personalized by the user to include one or more desired links in a navigation bar and the desired combination of information containers on the screen. A Home Page link may be included in the navigation bar or area so that the user can return to the Home Page from other pages, such as a To-Do List page, a My Objects page, etc.

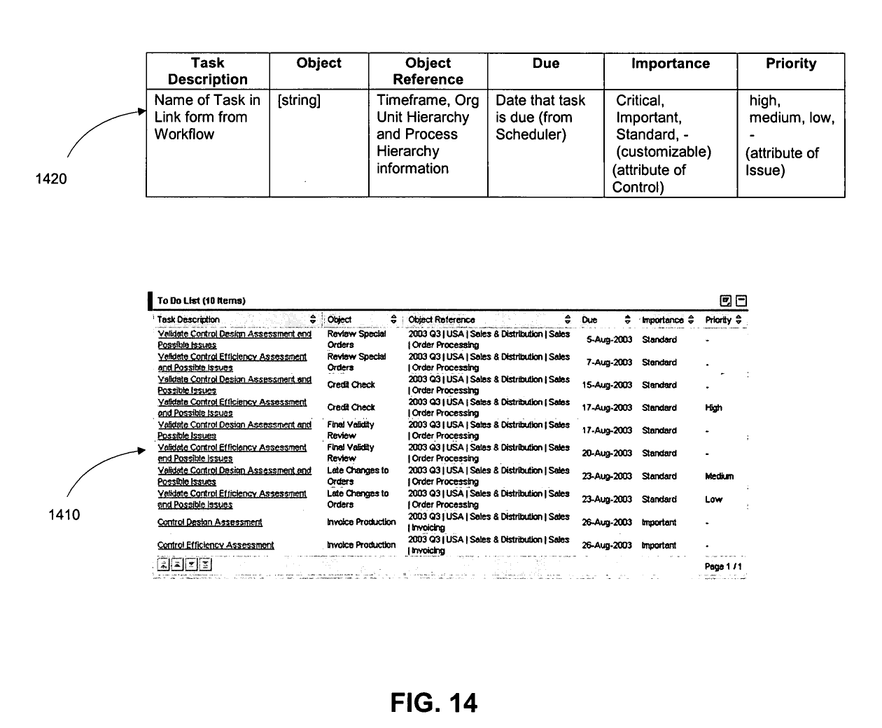

From a base web page (or any other page provided in accordance with the present invention), a To-Do List link may provide a reference to a information reflecting a list of activities assigned to the given user. The number of tasks included in the list may be displayed as part of a ServiceLink. For example, FIG. 14 shows a screen shot 1410 of an exemplary To-Do List that may be generated for a user of a business unit and a corresponding data structure 1420 for each To-Do object included in the To-Do List.

In one aspect, objects in the To-Do List that are rendered in a user interface screen may be data-driven based on the tasks that have been triggered by a scheduler process. The Links may include entity- and object-specific information to clarify the tasks that the particular user is to perform to assist, for example, in the management of internal controls.

The base web page (i.e., Home Page) may also include a My Objects link that references another page that includes the objects (e.g., organization unit, business process group, business process, and control) for which the user is the responsible person or owner. Whether a user is a person with such responsibilities may be determined by an evaluation of the task assignment process. This process is associated with the ability for a user or software executed process to assign tasks to an individual based on, for example, the object associated with a task.

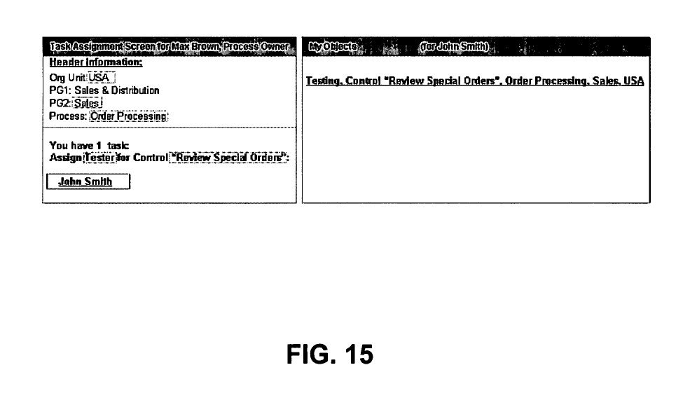

Accordingly, tasks may include associations to objects to determine whether an object should be included in a My Objects information container. Table I lists exemplary tasks for exemplary objects that may be assigned to users of an organization. FIG. 15 illustrates an exemplary assignment screen that methods and systems may provide to facilitate the assignment of tasks to a user's My Objects information container.

TABLE I
Exemplary Object/Task Table

| Object | Task |
|---|---|
| Org Unit | Assessment of Management Controls/Perform Management |
| | Control Assessment at Org. Unit Level |
| | Assessment of Management Controls/Validate Management |
| | Control Assessment for subordinated Org. Unit |
| Business | Assessment of Management Controls/Perform Management |
| process | Control Assessment at PG Level |
| Group | Assessment of Management Controls/Validate Management |
| | Control Assessment for subordinated Business process Groups |
| Business | Assessment of Business process Design/Perform Business |
| process | process Design Assessment |
| | Assessment of Business process Design/Validate Business |
| | process Design Assessment |
| Control | Assessment of Control Design and Efficiency/Perform |
| | Control Design Assessment |
| | Assessment of Control Design and Efficiency/Validate |
| | Control Design Assessment |
| | Assessment of Control Design and Efficiency/Perform |
| | Control Efficiency Assessment |
| | Assessment of Control Design and Efficiency/Validate |
| | Control Efficiency Assessment |
| | Testing/Perform Testing |
| | Testing/Receive Effectiveness Issues as Issue Owner |
| | Issues and Remediation/Create Remediation Plan |
| | or resolve issue |
| | Issues and Remediation/Perform remediation plan |

Methods and systems consistent with aspects of the present invention may leverage the user-interactive capabilities described above to manage workflows that are associated with the assessment and remediation of internal controls. As mentioned above, different types of workflows may be implemented that assist an organization in managing these types of controls. For example, an assessment of control design workflow may by performed that serves as a readiness assessment for certain governmental requirements, such as those set forth in Sections 404 and/or 302 of the SOA. This type of workflow may be implemented to allow an organization's management to identify and remediate control issues early, thus reducing the workload on subsequent control testing procedures. Another exemplary workflow, the assessment of control efficiency, may be performed at runtime and allows management to evaluate the effectiveness of resources used at the control level of an organization. For instance, a control may be a well designed manual process that could be made more efficient by automation.

When performing certain internal control management workflows, methods and-systems of the present invention may ensure that a control assessment is performed (i.e., of control design or efficiency), the assessment is validated by the appropriate individuals, issues associated with the control is identified and remediated, and the progress of the above workflow steps is monitored on a continuous basis. Accordingly, aspects of the present invention may enable methods and system to assess an organization's internal controls, identify any potential issues or problem with the controls, provide mechanisms to implement remediation plans to remedy the issues, and test the effectiveness of the remediated controls.

FIG. 16 illustrates a flowchart of an exemplary assessment and remediation of internal control process 1600 that may be performed during the management of internal control process described above in connection with FIG. 2. As shown in the example of FIG. 16, methods and systems may perform an assessment of the controls implemented in an organization (Step 1610). The assessment may be performed by one or more individuals in an organization tasked with such activities, such as a manager who is to assess the controls created by another employee of the organization. Alternatively, computer executed software may automatically perform an assessment of one or more controls using stored information reflecting the controls, their objective, and their impact on defined risks associated with the objectives.

Additionally, assessing the controls may also include providing a rating for the controls based on the assessment. In one aspect, controls may be rated according to predetermined levels, such as an adequate level, a deficient level, and a significantly deficient level. To leverage the user interface capabilities of aspects of the present invention, methods and system may use graphical representations on a user display to reflect selected control rating levels, such as a green symbol for adequate, a yellow symbol for deficient, and a red symbol for significantly deficient. Other forms of user interface symbols or representations may be implemented to present the status of a current rating level of an assessed control.

In addition to assessing controls, methods and systems may identify any issues associated-with a control or business process (Step 1620). An issue may be a shortcoming or problem related to a control or a business process implemented by a business unit, organization unit, or the organization. In one embodiment, there may be at least three types of issues associated with the management of internal controls: design, effectiveness, and efficiency issues. Design and effectiveness issues may be those deemed to be relevant to any governmental or other form of regulatory standard (i.e., the SOA) and will prevent the defined control objectives from being met for a given business process. Efficiency issues may be related to the performance of the controls used by the organization and may not be relevant to meeting any standards of a governmental requirement, such as the SOA. Efficiency issues, however, may be relevant to the organization in assisting in managing internal controls.

Issues may be identified and defined automatically by a computer executed software process configured to evaluate data reflecting given controls and associated remediation plan (described below). Alternatively, issues may be identified and defined by a user implementing one or more software programs that provide one or more user interfaces generated by methods and systems consistent with aspects of the present invention. Each defined issue may be monitored on a business unit, business process group, business process, and control level basis. An issue may also be assigned to multiple controls.

In defining issues, methods and systems may allow a user to configure one or more attributes, such as a root cause (i.e., what caused the issue. to be created), implication (i.e., the affect of the issue), owner (i.e., a person who is address the issue), issue source identifier (i.e., a person who identified the issue), and/or a timestamp (i.e., when the issue was identified). Further examples of issue attributes may include an issue type (e.g., design, effectiveness, and efficiency) and an issue priority level. Also, issue status (e.g., open, remediated, and closed), remediation plan (e.g., one or many), and issue validation date (e.g., when the issue was remediated and validated (i.e., signed-off by an authorized person)) attributes may be used in defining an issue. Methods and systems of the present invention may use the issue attributes to create user interfaces that are presented to selected persons for managing the internal controls of the organization.

Once an issue is identified and defined, the assessment of the control(s) is validated (Step 1630). The issues may be addressed by creating one or more remediation plan(s) that are procedures created by a user to address and recitify the identified issue (Step 1640). The remediation plan(s) are then reviewed and validated by one or more authorized persons if the plans sufficiently address the identified issue(s) (Step 1650). Subsequently, the remediation plan(s) and the remediated issue(s) are closed (Step 1660).

As explained, aspects of the present invention may leverage computer executed processes to generate user interfaces to assign and monitor one or more tasks in an organization. These user interfaces may be used to perform an assessment and remediation of internal controls process, such as that shown in FIG. 16. For example, the To-Do List user interface previously described may be leveraged to present certain tasks to selected persons to perform assessments of controls, define issues, validate assessments, create remediation plans, validate the plans, and close the issues and remediation plans.

Exemplary Assessment of Control Design Workflow

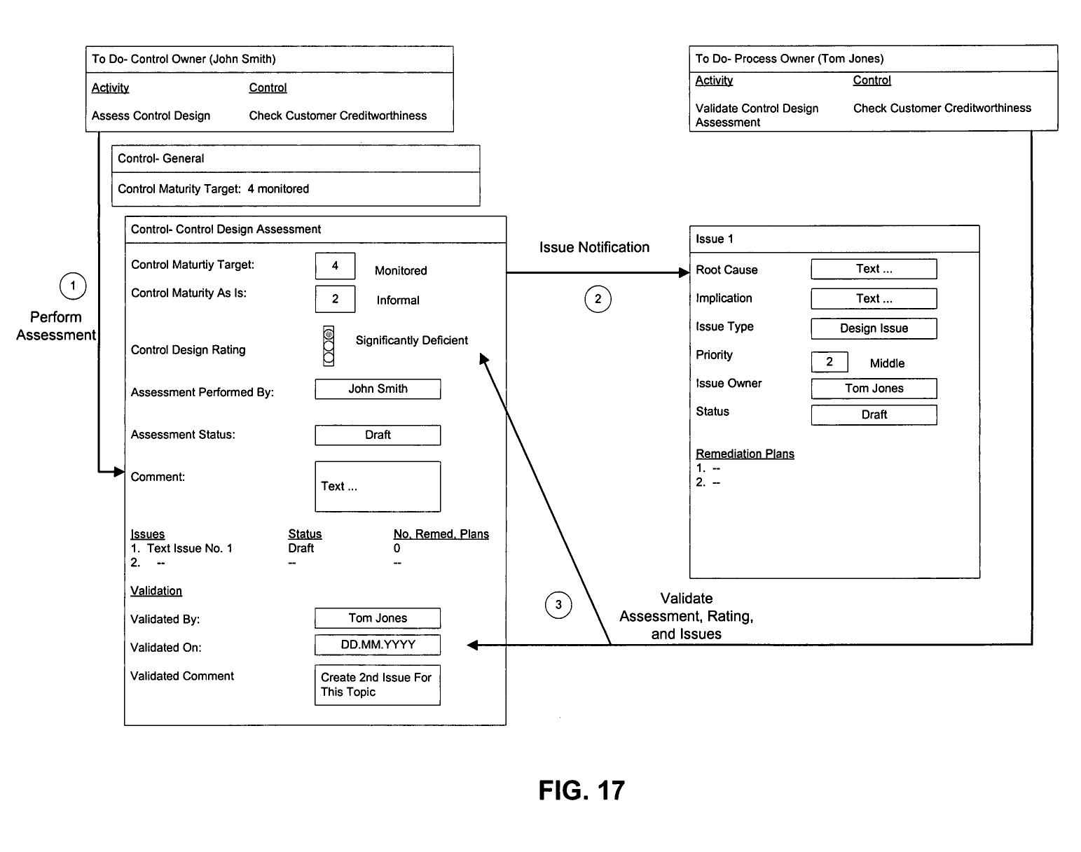

To further illustrate the above-mentioned aspects of the invention, FIGS. 17-21 illustrate block diagrams of exemplary process flows for performing an assessment of control design workflow. Although the following description of FIGS. 17-21 describe a control design assessment, methods and systems of the present invention may use similar process flows to perform other types of workflows for managing internal controls, such as assessment of control efficiency workflows, etc.

As shown in FIG. 17, to assess a control design, a To-Do list may be created for a control owner (i.e., “John smith”) and a business process owner (i.e., “Tom Jones”). The To-Do list presents to these individuals an activity to be performed and an associated control. In this example, the control owner may assess an exemplary control design (i.e., process flow 1). Methods and systems consistent with aspects of the present invention may provide additional user interfaces that enable the control owner and business process owner to input feedback based on their assigned activity in the To-Do list.

In the example of FIG. 17, a control interface for “Control Design Assessment” is provided that enables the control owner (i.e., John Smith”) to provide the results of their analysis of the monitored control (i.e., “Check Customer Creditworthiness”). Among the information that may be provided is a control design rating that may be set based on predetermined levels, such as adequate, deficient, and significantly deficient. In FIG. 17, the exemplary control is rated as significantly deficient by the control owner following the assessment of the control design.

During an assessment of the control design, the control owner may identify one or more issues associated with a given control. This information may be presented in another user interface that enables the control owner to provide attribute values for the issue identified (i.e., process flow 2). As shown in FIG. 17, the exemplary issue 1 includes an attribute identifying an issue owner that is responsible for the issue.

Also, the business process owner may perform activities included in their To-Do list (i.e., “Validate Control Design Assessment”). Thus, in this example, the business process owner validates the assessment, rating, and issues provided by the control owner. Additionally, in accordance with one embodiment, the business process owner may provide information regarding this assessment in the control interface (i.e., process flow 3). As shown in FIG. 17, a request to create a second issue is presented by the business process owner (e.g., “Validated Comment”).

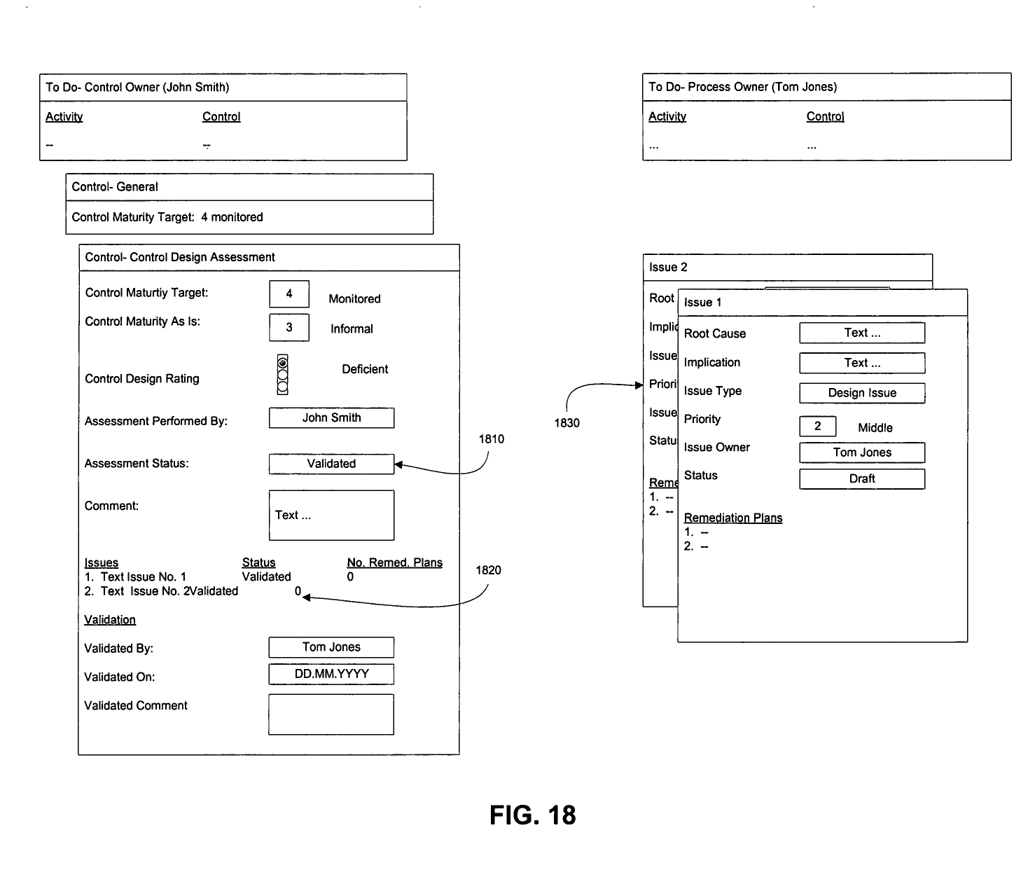

Based on the validation by the business process owner, the control owner may perform one or more additional tasks to address any requests provided by the business process owner. In this example, the control owner creates a second issue as requested by the business process owner. FIG. 18 shows an exemplary block diagram resulting from this activity. As shown in FIG. 18, a second issue is created, represented by container 1830. The assessmentsof the control design may be validated (1810) by the control owner and the assessment performed by the control owner may be further validated by the business process owner, represented by status element 1820.

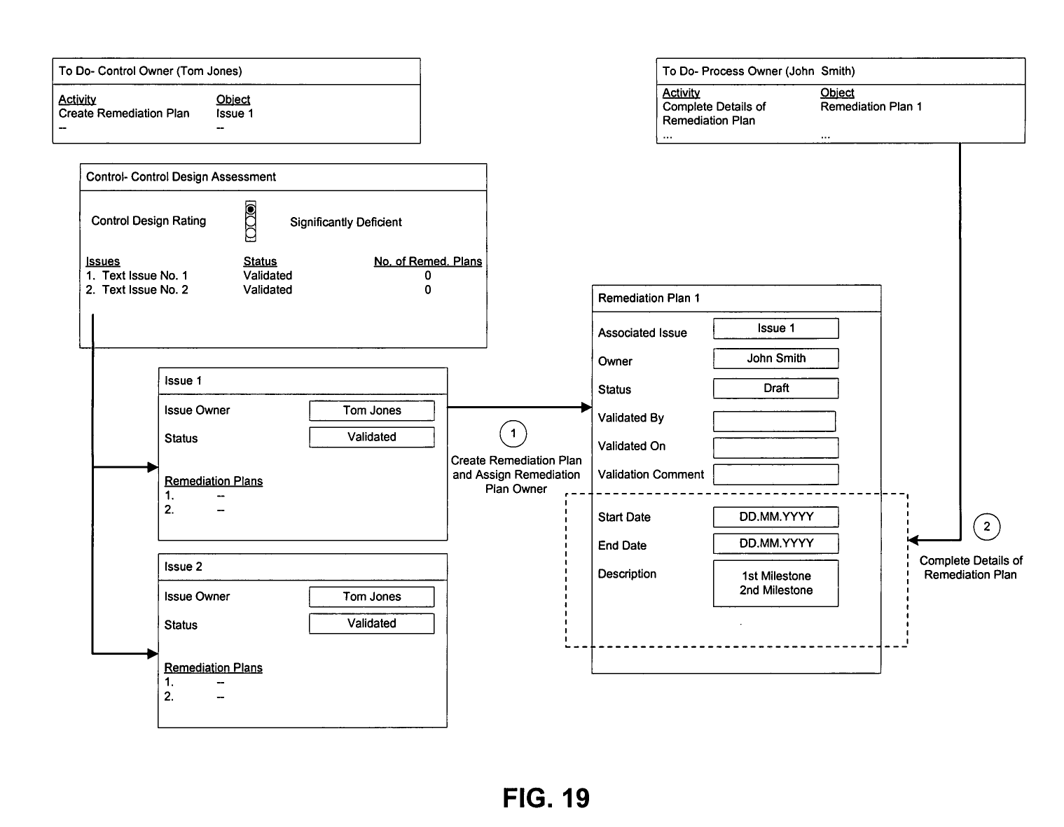

Once one or more issues are created for a given control, remediation plans may be required to address any problems presented by the issues. FIG. 19 shows a block diagram of exemplary interfaces and process flows associated with creating such plans. As shown, the To-Do lists for an issue owner (i.e., Tom Jones) and business process owner (i.e., John Smith) is created reflecting any activities for a given object that require performance. For each issue, the issue owner may create a remediation plan and assign a remediation plan owner tasked with the plan (i.e., process flow 1). Based on the activity presented in the To-Do list, the business process owner may-perform some task associated with the created remediation plan. In this example, the business process owner completes details of the remediation plan created by the issue owner (i.e., process flow 2).

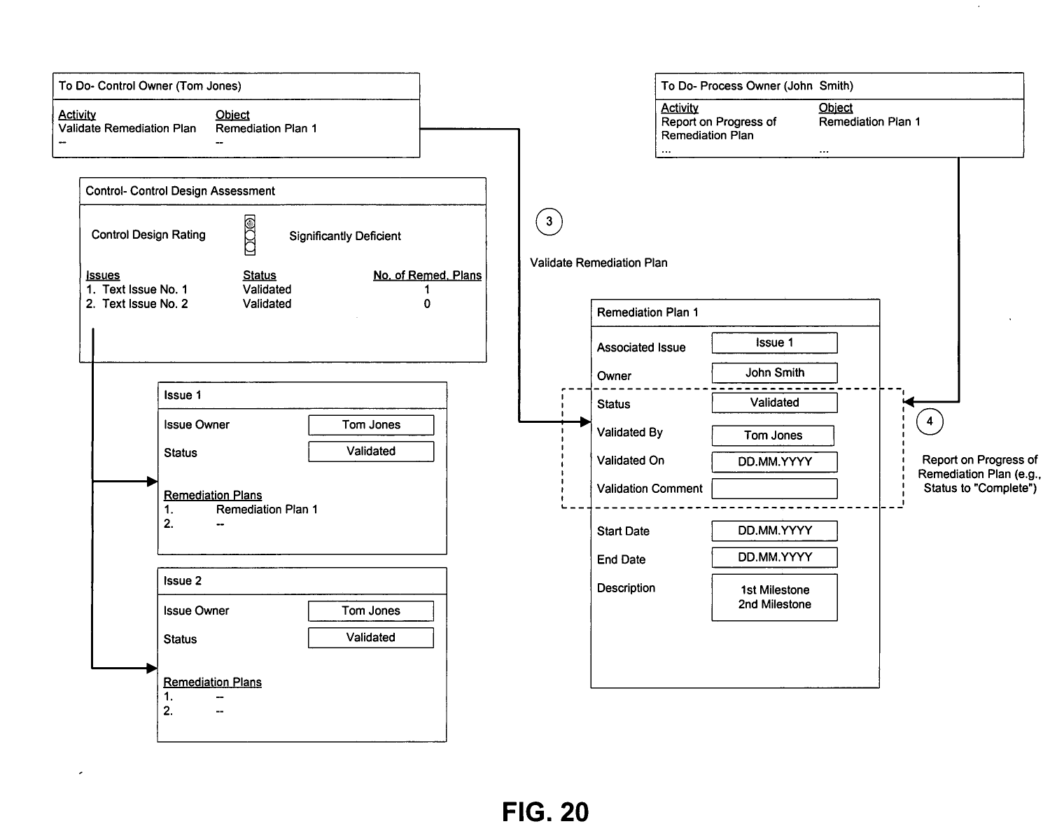

Once a remediation plan is created and detailed, it may be validated by the issue owner. FIG. 20 shows a block diagram of exemplary interfaces and process flows associated with this aspect of the exemplary assessment process. As shown, the To-Do list for the issue owner may be updated to show an activity for validating the remediation plan (i.e., process flow 3). Additionally, an activity for the business process owner may require them to report on the progress of the remediation plan. Exemplary user interfaces may be created and provided that allow attributes for the remediation plan to be updated by the appropriate individuals (i.e., process flow 4).

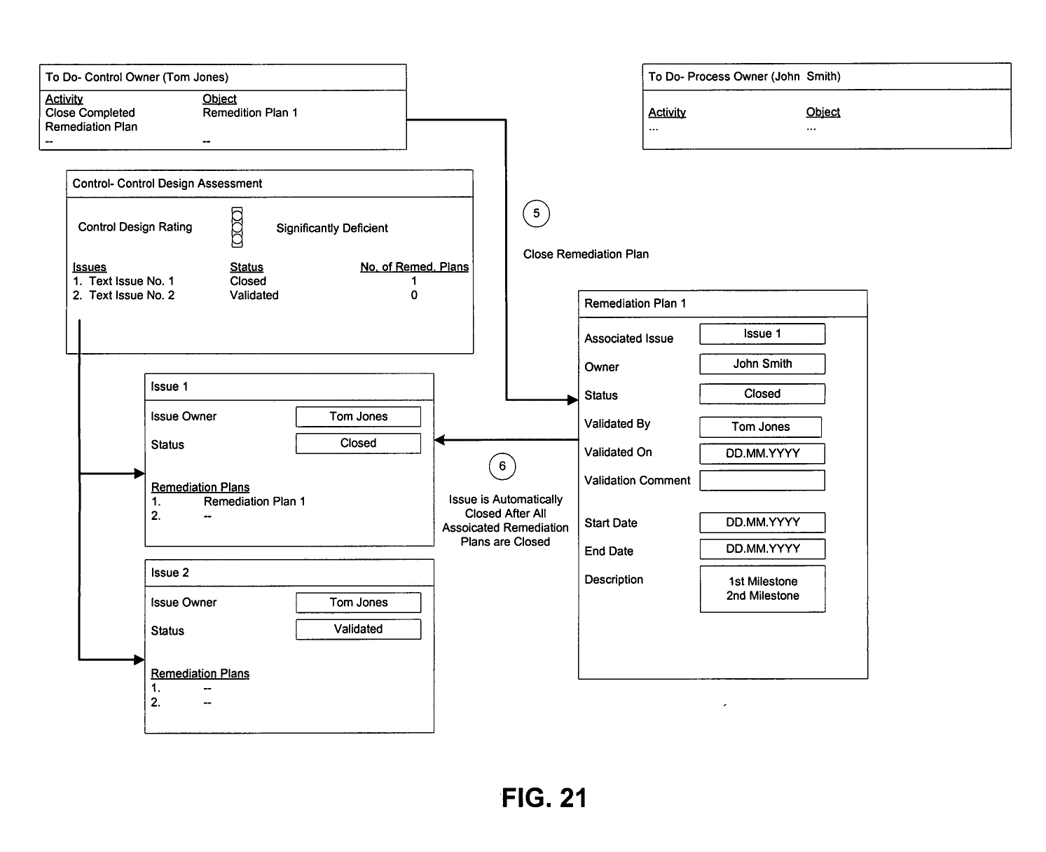

Once a remediation plan is validated and successfully addresses any issues previously identified, the plan and issue may be closed. FIG. 21 illustrates a block diagram of exemplary interfaces and process flows associated with this aspect. As shown in FIG. 21, the To-Do lists for the issue owner and business process owner may be updated to reflect any activities that require performing. In this example, the issue owner (i.e., Tom Jones) is tasked with closing the completed remediation plan, while the business process owner has no tasks assigned. Accordingly, the issue owner proceeds to close the plan (i.e., process flow 5), which is reflected in an exemplary interface that adjusts a status attribute associated with the remediation plan. In one embodiment, methods and systems consistent with the present invention may automatically close the issue after all associated remediation plans are closed (i.e., process flow 6), and the appropriate attributes in the issue and control interfaces may be updated.

Testing and Remediation of Internal Controls

In the above-described example, a control design is assessed, validated, and accepted for use in an organization. An organization, however, may wish to ensure that the controls that were designed effectively provide procedures that meet the requirements the control was designed to address. Thus, referring back to FIG. 2, once the assessment and remediation of internal controls is completed, the controls may be tested and remediated (Step 240). In certain embodiments, methods and systems may employ user interfaces and computer executed processes to provide a means for facilitating the testing of controls and the creation of remediation plans for addressing any issues identified during the testing.

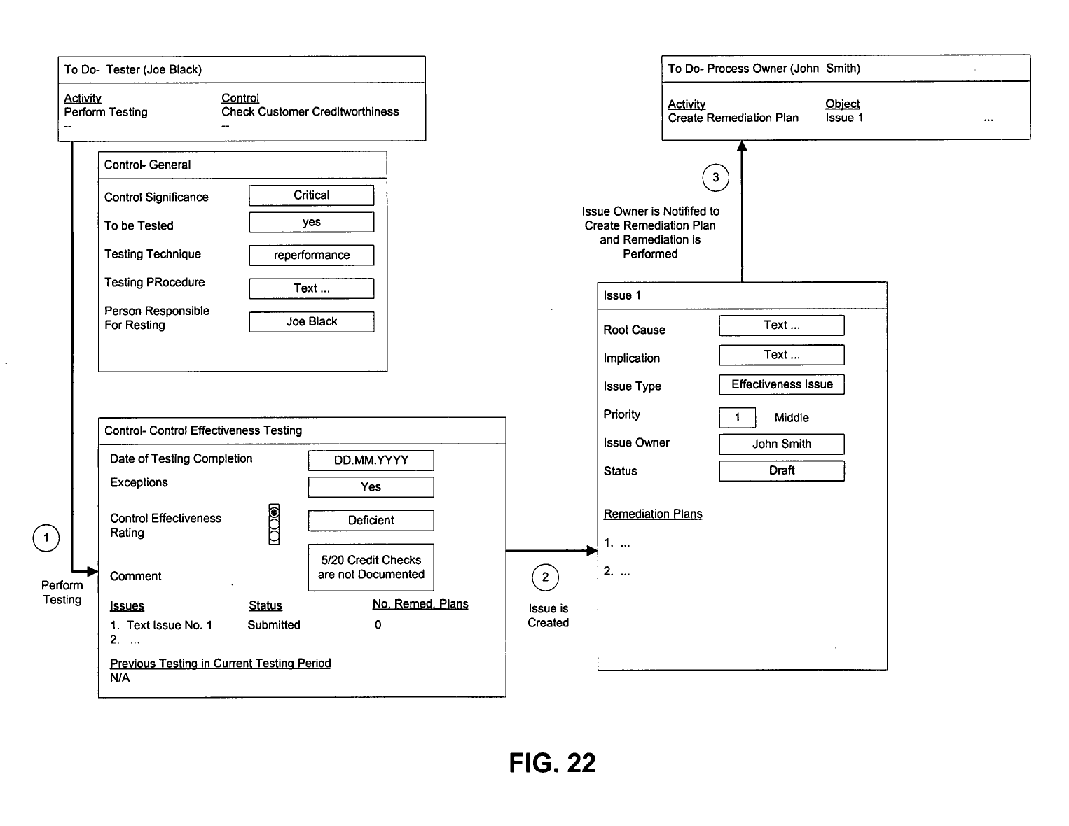

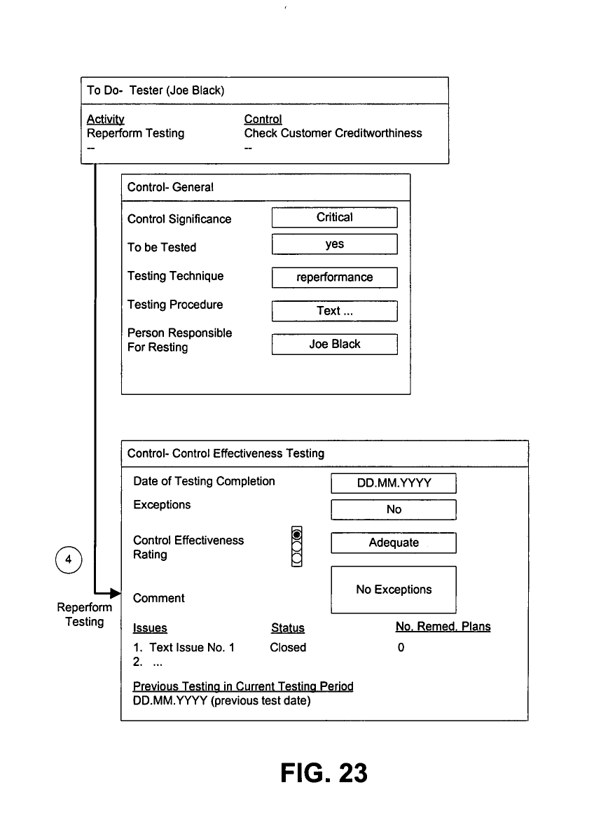

FIGS. 22 and 23 illustrate block diagrams of exemplary interfaces and process flows associated with these aspects of the present invention. As shown in FIG. 22, an individual (i.e., Joe Black) may be tasked with testing a selected control through the use of a To-Do list (i.e., Perform Testing Activity). Based on this assignment, the tester may perform testing of the control (i.e., process flow 1). During testing, the tester may identify one or more issues associated with the control. In this example, the effectiveness of a selected control is monitored and an issue is identified and created based on the monitoring (i.e., process flow 2). By way of example, FIG. 22 shows an attribute reflecting that the control is deficient for a particular reason (i.e., “a certain number of credit checks are-not documented”).

Using an interface, the tester may update attributes for the created issue to allow an issue owner's To-Do list to be updated accordingly. In this case, the issue owner (i.e., John Smith) is notified through an activity provided in the owner's To-Do list (i.e., process flow 3). For example, because an issue is identified, the issue owner may be tasked with creating and performing a remediation plan to address the issue.

Once the remediation plan is performed and successfully addresses the issue identified by the tester, the issue owner may close the remediation plan. Once all associated remediation plans are closed, the identified issue may be closed automatically. Further, once all issues associated to a given test performed by the tester are closed, the tester may receive a notification to retest the control to ensure no additional issues are identified. FIG. 23 illustrates a block diagram of exemplary interfaces and process flows associated with this exemplary aspect of the present invention.

As shown in FIG. 23, the To-Do list for the tester may be updated with an activity to re-perform testing of the control (i.e., process flow 4). Based on the subsequent test, the tester may update the control effectiveness rating attribute to signify that the control is either adequate or is still deficient (or significantly deficient). In the exemplary control interface shown in FIG. 23, the retest of the control results in an adequate rating for the control.

Sign-Off and Reporting

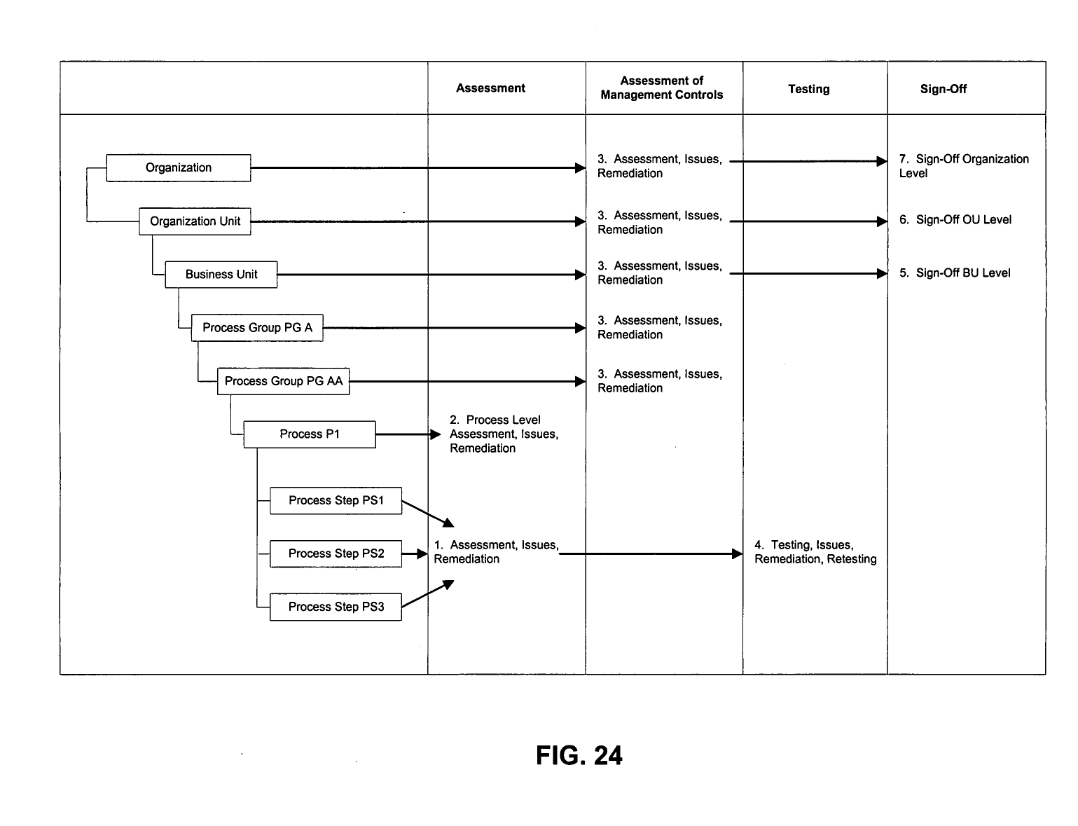

Once all of the appropriate testing, remediation, and validation of an organization's internal controls are complete, the management of these controls may be signed-off and reported to the appropriate individuals, organizations, and/or governmental entities. An organization's hierarchy may control how the sign-off on particular controls and their management is performed. For example, FIG. 24 illustrates a block diagram of an exemplary organization hierarchy related to corresponding business process steps associated with the organization's internal controls and ultimately the proper sign-off of the control's management.

As shown, the assessment of controls at the business process step level may be the first procedures performed during the management of internal controls (i.e., Step 1, Assessment, Issues, and Remediation). At the business process level, a subsequent step of assessing controls, identifying issues, and remediation may be performed (i.e., Step 2, Process Level Assessment, Issues, Remediation). Subsequently, during the assessment of the management of the controls, one or more of the higher levels of the organization may also perform assessment, issue identification, and remediation of the issues (i.e., Step 3, Assessment, Issues, Remediation at the business process group, business unit, organization unit, and organization level).

As explained above, once all issues are remediated and the design and efficiencies of the controls are validated by the appropriate organization level representatives, the testing of the controls may be performed (i.e., Step 4, Testing, Issues, Remediation, and Retesting). Only once the controls have been properly tested and validated, the appropriate representatives of an organization's levels may sign-off on the management of these controls. In some aspects, the sign-off process may be performed in hierarchical fashion, following the hierarchy of the organization. For example, as shown in FIG. 24, the business unit levels sign-off the management of the controls before their corresponding organization units. And once all of the organization units have sign-off on the management of the internal controls, the organization may sign-off through the appropriate executive personnel, such as a CEO or CFO.

Methods and systems consistent with aspects of the present invention may incorporate user interfaces and computer-executed software to enable authorized individuals in an organization to not only ensure workflow tasks have been properly reviewed and validated by lower level authorities (i.e., managers, etc.), but also allow reports to be created using the information maintained during the management of the internal controls described above.

By way of example, embodiments consistent with the invention may generate one or more business reports associated with the management of internal controls using the information obtained during the various stages of managing the internal controls, such as assessment, assessment of management controls, testing, and sign-off. In one aspect, methods and systems may-collect information from data structures storing attributes associated and other related data associated with given controls, business processes and process groups, such as the attributes provided by users via the exemplary user interfaces described above in connection with FIGS. 17-21.

In one aspect, a first type of report is generated that may be used to support the assessment of control designs at various business process levels. This type of report may provide information reflecting the ratings for certain controls, the assignment of the controls with business processes, any issues associated with the controls, business process, and business process groups, and identification of responsible persons for a given business process, control, and business process group.

Methods and systems consistent with the present invention may also generate a second type of report that may be used to support business process analysis and determinations whether all control objectives and risks are adequately covered by existing controls. This report may include information reflecting identifications of any control objectives and/or risks not addressed by the existing controls, identification of any controls and risks that are addressed repeatedly, analysis results associated with each business process and related to discovering an proper combination of preventive and detective controls used in the organization, and identification of any control types that are not adequately represented in the existing controls (e.g., financial reporting, accuracy, completeness, validity, etc.).

The above-described reports are exemplary and are not intended to be limiting. Other types of reports may be generated for providing one or more individuals of an organization, organization unit, and business unit with information regarding the status of various aspects of the organization's management of internal controls. For example, in situations where an organization is required to report to the SEC in accordance with Sections 302 and 404 of the SOA, methods and systems may generate reports and/or assist a CEO/CFO in generating a report that meets the requirements of these sections.

For instance, an individual may leverage one or more user interfaces to view the status of lower organization level control assessments to determine whether certain requirements have been met. The interfaces may include information and/or rating symbols reflecting the status of selected sign-off status reports of lower level individuals, thus allowing an upper organization level manager to determine whether certain processes have been properly evaluated and signed-off. Once the upper level manager approves and signs-off on a given report, the report may be provided to the necessary governmental entities in accordance with governing law.

Exemplary System

As disclosed herein, embodiment of the invention may be implemented using any combination of computer hardware, software and/or firmware. These aspects may be implemented as a computer program product (i.e., a computer program tangibly embodied in an information carrier such as a machine-readable storage device or in a propagated signal), for execution by, or to control the operation of, data processing apparatus.(e.g., a programmable processor, a computer, or multiple computers). Computer programs consistent with the invention may be written in any form of programming language and can be deployed to be executed on one computer or on multiple computers at one site or distributed across multiple sites and interconnected by a communication network.

For example, the features disclosed herein may be performed through one or more software modules or as part of a Management of Internal Controls (MIC) software application. Such software may be executed in a computerized system or networked environment. Through a MIC application or other appropriate software, one or more-persons may automatically inform one another when a subsequent person needs to be involved and perform specific task(s) in a workflow. Thus, method steps of the invention and its embodiments may be performed by one or more programmable processors executing a computer program to perform functions of the invention by operating on input data and generating output.

Processors suitable for the execution of a computer program may include, by way of example, both general and special purpose microprocessors, and any one or more processors of any kind of digital computer. Generally, a processor may receive instructions and data from a read-only memory or a random access memory or both. The essential elements of a computer may be a processor for executing instructions and one or more memory devices for storing instructions and data. Generally, a computer may also include, or be operatively coupled to receive data from or transfer data to, or both, one or more mass storage devices for storing data (e.g., magnetic, magneto-optical disks, or optical disks). Information carriers suitable for embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, embodiments consistent with the invention may be implemented on a computer having a display device such as a CRT (cathode ray tube) or LCD (liquid crystal display) monitor for displaying information to the user and a keyboard and a pointing device such as a mouse or a trackball by which the user may provide input to the computer. Other kinds of devices may be used to provide for interaction with a user as well; for example, feedback provided to the user may be any form of sensory feedback, such as visual feedback, auditory feedback, or haptic feedback; and input from the user may be received in any form, including acoustic, speech, or haptic input.

Other embodiments of the invention will be apparent to those skilled in the art from consideration of the specification and practice of the invention disclosed herein. The exemplary implementations of the invention included herein have been presented for purposes of illustration and description. They are not exhaustive and do not limit the invention to the precise form disclosed. Modifications and variations are possible in light of the above teachings or may be acquired from the practicing of the invention.

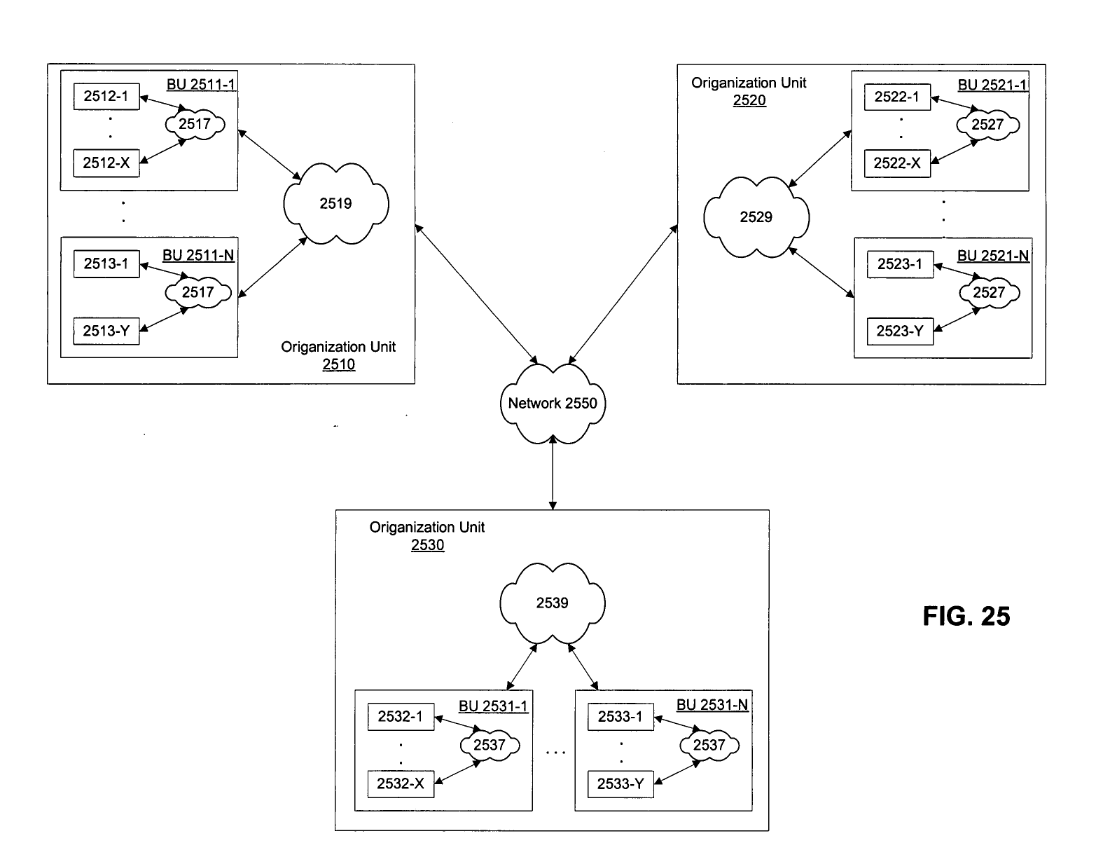

By way of example, FIG. 25 shows a block diagram of an exemplary arrangement of corporate organization 100 illustrated in FIG. 1 from a computer system environment standpoint. In certain aspects, each BU in OUs 110,120, and 130 may include computer systems operated by one or more persons associated with a respective BU. For example, as shown in FIG. 25, BUs 2511-1 to 2511-N may each include one or more computer systems 2512-1 to 2512-X and 2513-1 to 2513-Y, respectively, where “X,” “N.” and “Y” are integers greater than zero. Any number of such systems may be implemented in BUs 2511-1 to 2511-N. Further, although the following description of FIG. 25 provides details of computer systems associated with OU 2510, OUs 2520 and 2530 may include similar type of computer systems. Accordingly, the following description of the computer systems included in BUs 2512-1 to 2512-X and/or 2513-1 to 2513-Y apply to OUs 2520 and 2530. For example, FIG. 25 shows OU 2520 including computer systems 2522-1 to 2522-X and 2523-1 to 2523-Y in BUs 2521-1 to 2521-N, respectively. Further, FIG. 25 shows OU 2530 including computer systems 2532-1 to 2532-X and 2533-1 to 2533-Y in BUs 2531-1 to 2531 -N, respectively.

In certain aspects, computer systems 2512-1 to 2512-X and 2513-1 to 2513-Y may comprise a desktop, mainframe, laptop, or any other type of computer system known in the art. Further, computer systems 2512-1 to 2512-X and 2513-1 to 2513-Y may each operate as a server computer, client computer, or both. These computer systems may be operated by one or more individuals associated with the respective business units of organization 100. Additionally, OU 2510 may include one or more computer systems (not shown) operated by individuals associated with organization unit level, such as organization unit level managers, executives, staff, etc.

Computer systems 2512-1 to 2512-X and 2513-1 to 2513-Y may each include any known components used in performing processes consistent with certain aspects related to the present invention. For example, computer systems 2512-1 to 2512-X and 2513-1 to 2513-Y may each include a processor system, a memory system, an interface system, and a display device.

A processor system implemented in a BU computer system may include one or more processors suitable for the execution of one or more computer programs. The processors may include, by way of example, both general and special purpose microprocessors, and any one or more processors of any kind used in computer systems. Generally, a processor may receive instructions and data from a read-only memory or a random access memory or both. Further, the processor system may execute instructions and one or more memory devices for storing instructions and data.

A memory system implemented by an OU computer system may be one or more memory devices that store data and software programs that are executed by a processor system (e.g., magnetic, magneto-optical disks, or optical disks). The memory devices may store software programs that when executed by one or more processors, perform certain aspects of the present invention. For example, one or more of the computer systems included in BUs 2511-1 to 2511-N may execute a MIC application for managing internal controls for organization 100. Further, user interface software may be stored and executed to provide one or more individuals with content for managing the internal controls, such as a To-Do list and a MY Objects web page.

A display device may be a device, such as a CRT (cathode ray tube) or LCD (liquid crystal display) monitor, for displaying information to a user and a keyboard and/or a pointing device (e.g., mouse or a trackball) by which the user may provide input to the computer system. Other types of devices may be used to provide for computer system interaction with a user as well; for example, feedback provided to the user maybe any form of sensory feedback, such as visual feedback, auditory feedback, or haptic feedback; and input from the user may be received in any form, including acoustic, speech, or haptic input.

Additionally, computer systems 2512-1 to 2512-X and 2513-1 to 2513-Y may be interconnected by an internal network 2519. In one aspect, network 2519 maybe one or more networks that interconnect computer systems 2512-1 to 2512-X and 2513-1 to 2513-Y to exchange information within OU 2510. For example, network 2519 may be a Local Area Network (LAN), an Extranet, an Intranet, and any other type of communication network known in the art. Also, as shown in FIG. 25, OUs 2510, 2520, and 2530 may be interconnected by a network 2550. This network may be one or more communication networks, such as the Internet, a WAN, LAN, wireless and/or wireline based communication networks, and any other form of communication network that enables OUs 2510, 2520, and 2530 to exchange information.

For purposes of explanation only, certain aspects of the present invention may be performed using the discrete functional elements illustrated in FIG. 25. The functionality of the elements and modules illustrated in FIG. 25 may, however, overlap and/or may be present in a fewer or greater number of elements and modules. Elements of each system may, depending on the implementation, lack certain illustrated components and/or contain, or be coupled to, additional or varying components not shown. Further, all or part of the functionality of the illustrated elements may co-exist or be distributed among several geographically dispersed locations. Moreover, embodiments, features, aspects and principles of the present invention may be implemented in various environments and are not limited to the illustrated environments and architectures. In addition, the processes disclosed herein are not inherently related to any particular apparatus or system and may be implemented by any suitable combination of components.

As described, embodiments of the present invention enable an organization to manage workflows. In accordance with certain aspects, a cascaded process of scheduling and assigning activities may be performed that enables users affiliated with various hierarchical levels of organization 100 to manage these activities. For example, a top-level user, such as a system administrator, may initially schedule a workflow including corporate level activities. Following the schedule, lower organization level users may assign activities based on the schedule assigned by the system administrator. Through user To-Do lists and/or other similar notification schemes, methods and systems of the present invention may enable users of an organization to schedule and assign activities that meet the criteria of the initially schedule workflow, but include additional activities unique to a given user or organization level. For example, managers of a business unit may schedule a workfldw and assign activities that are unique to that business unit, while at the same time meeting the scheduled workflow initially set forth by the corporate level system administrator. Further, process group managers that are assigned tasks by the business unit manager may also schedule and assign activities unique to his/her organization level, while still meeting the goals set forth by the business unit manager.

1. A computer-implemented method for handling and managing workflows in an organization, the method comprising:
assigning roles to persons in the organization, each role comprising one or more responsibilities for each person assigned to a role;
defining and scheduling workflows for managing internal controls of the organization, each workflow comprising a plurality of tasks to be performed by persons in the organization according to their assigned roles; and
communicating required tasks of each workflow to persons in the organization through respective dedicated interfaces for each person.

2. The computer-implemented method of claim 1, wherein each dedicated interface presents a To-Do list including the required tasks to be performed by each respective person.

3. The computer-implemented method of claim 1, wherein defining and scheduling workflows includes:
determining a structured organization hierarchy of the organization;
generating a business process catalog based on the organization hierarchy; and
linking business process in the business process catalog to one or more financial statement documents for the organization.

4. The computer-implemented method of claim 1, wherein defining and scheduling workflows includes:
defining control objectives;
defining a risk associated with each control objective; and
creating a control objective and risk catalog reflecting relationships between each risk and corresponding control objective.

5. The computer-implemented method of claim 1, wherein defining and scheduling workflows includes:
assigning one or more business processes to respective business units of the organization.

6. The computer-implemented method of claim 1, wherein defining and scheduling workflows includes:
defining business processes for respective business units of the organization; and
defining business process steps for each business process.

7. The computer-implemented method of claim 6, wherein defining and scheduling workflows includes:
assigning risks to one or more internal controls associated with a control objective for each business process; and
embedding the one or more controls to a respective business process.

8. The computer-implemented method of claim 1, wherein communicating required tasks includes: assigning a list of activities for each person assigned a role corresponding to the workflows for managing internal controls; and
generating each dedicated interface based on the list of activities for each person.

9. The computer-implemented method of claim 8, wherein the workflows include a first workflow and wherein a first person is assigned a first activity associated with the first workflow, and wherein the method further includes:
generating an assessment interface that enables the first person to record results of the first activity when performed by the first person.

10. The computer-implemented method of claim 9, further including:
generating an issue interface that enables the first person to input issue attributes associated with an identified issue corresponding to the first activity.

11. The computer-implemented method of claim 10, wherein a second person is assigned a second activity associated with the first workflow, and the method further includes:
allowing the second person to update the assessment interface based on results of the second activity when performed by the second person.

12. The computer-implemented method of claim 10, wherein the issue attributes direct a second person to perform a second activity associated with the identified issue.

13. The computer-implemented method of claim 12, wherein the second activity includes creating a remediation plan that addresses the identified issue.

14. The computer-implemented method of claim 13, wherein the second activity includes validating the remediation plan after the first person refines the remediation plan.

15. The computer-implemented method of claim 14, further including:
closing the identified issue once the remediation plan is validated.

16. The computer-implemented method of claim 1, wherein communicating required tasks includes:
assigning a first activity to a first person and a second activity to a second person, each activity corresponding to a first workflow for managing internal controls; and
generating a dedicated interface for each of the first and second person based on the first and second activities, respectively.

17. The computer-implemented method of claim 16, wherein the first person is assigned a role that requires the first person to oversee the second activity assigned to the second person.

18. The computer-implemented method of claim 1, further including:
assigning a first task to a first person to test results of one or more tasks performed by selected persons for managing internal controls of the organization; and
generating a test interface that allows the first person to input data reflecting results of the first task.

19. The computer-implemented method of claim 1, further including:
generating sign-off interfaces for persons associated with various business levels of the organization, each sign-off interface enabling a specified person to validate internal control related tasks performed by one or more persons overseen by the specified person.

20. The computer-implemented method of claim 19, wherein generating sign-off interfaces includes:
generating a report based on the validation of the internal control related tasks by each specified person.

21. The computer-implemented method of claim 20, wherein the report is validated by a person who is responsible for overseeing the entire organization.

22. The computer-implemented method of claim 20, wherein the report includes information reflecting the organization's attempt to manage internal controls of the organization.

23. The computer-implemented method of claim 20, wherein the report includes information reflecting the organization's attempt to manage internal controls of the organization based on a governmental standard.

24. The computer-implemented method of claim 1, further including:
generating dedicated interfaces for specified persons in the organization that enable these specified persons to validate the performance of one or more of the tasks performed by persons in the organization.

25. The computer-implemented method of claim 24, further including:
generating a report including information representing the organization's attempt in managing internal controls of the organization, wherein the report is generated based on the validation by the specified persons in the organization.

26. The computer-implemented method of claim 1, wherein the workflows include tasks to be performed by persons associated with different business units of the organization.

27. The computer-implemented method of claim 1, wherein the workflows include tasks to be performed by persons associated with different organization units of the organization.

28. The computer-implemented method of claim 1, wherein defining and scheduling workflows for managing internal controls of the organization, includes: scheduling, by a corporate level person in the organization, a corporate level workflow that includes activities for internal controls at a corporate level; and
assigning tasks to persons at the organization unit level to meet requirements of the scheduled corporate level workflow.

29. The computer-implemented method of claim 28, further comprising:
scheduling an organization unit level workflow based on the corporate level workflow; and
assigning tasks, by organization unit level persons, to meet requirements of the schedule organization unit level workflow, wherein the organization unit workflow includes tasks that are unique to the organization unit level.

30. The computer-implemented method of claim 29, further comprising:
cascading the scheduling of subsequent workflows to lower organization level entities of the organization, wherein each scheduled subsequent workflow includes tasks that meet the requirements of the corporate level workflow and includes tasks that are unique to an organization level entity associated with the subsequent workflow.

31. A system for managing workflows in an organization employing persons assigned roles, each role comprising one or more responsibilities for each person assigned to a role, the system including:
a network of computers associated with the organization, at least one of the computers executing software that provides dedicated user interfaces for:
defining and scheduling workflows for managing internal controls of the organization, each workflow comprising a plurality of tasks to be performed by persons in the organization according to their assigned roles, and
communicating tasks of each workflow to the persons in the organization.

32. The system of claim 31, wherein the computer network includes a first set of computers associated with a first business unit of the organization and a second set of computer associated with a second business unit of the organization.

33. The system of claim 31, wherein each dedicated interface presents a To-Do list including the required tasks to be performed by each respective person.

34. The system of claim 31, wherein the software provides user interfaces for:
defining a structured organization hierarchy of the organization;
generating a business process catalog based on the organization hierarchy; and
linking business process in the business process catalog to one or more financial accounts for the organization.

35. The system of claim 31, wherein the software performs processes for
defining control objectives;
defining a risk associated with each control objective; and
creating a control objective and risk catalog reflecting relationships between each risk and corresponding control objective.

36. The system of claim 31, wherein the software performs processes for assigning one or more business processes to respective business units of the organization.

37. The system of claim 31, wherein the software performs processes for:
defining business processes for respective business units of the organization; and
defining business process steps for each business process.

38. The system of claim 37, wherein the software performs processes for:
assigning risks to one or more internal controls associated with a control objective for each business process; and
embedding the one or more controls to a respective business process.

39. The system of claim 31, wherein the software is performs processes for:
assigning a list of activities for each person assigned a role corresponding to the workflows for managing internal controls; and
generating each dedicated interface based on the list of activities for each person.

40. The system of claim 39, wherein the workflow include a first workflow and wherein a first person is assigned a first activity associated with the first workflow, and wherein the software generates an assessment interface that enables the first person to record results of the first activity when performed by the first person.

41. The system of claim 40, wherein the software generates an issue interface that enables the first person to input issue attributes associated with an identified issue corresponding to the first activity.

42. The system of claim 41, wherein a second person is assigned a second activity associated with the first workflow, and the software performs processes that enable the second person to update the assessment interface based on results of the second activity when performed by the second person.

43. The system of claim 41, wherein the issue attributes include data directing a second person to perform a second activity associated with the identified issue.

44. The system of claim 43, wherein the second activity includes creating a remediation plan that addresses the identified issue.

45. The system of claim 44, wherein the second activity includes validating the remediation plan after the first person refines the remediation plan.

46. The system of claim 45, wherein the software performs processes that close the identified issue once the remediation plan is validated.

47. The system of claim 31, wherein the software performs processes for:
assigning a first activity to a first person and a second activity to a second person, each activity corresponding to a first workflow for managing internal controls; and
generating a dedicated interface for each of the first and second person based on the first and second activities, respectively.

48. The system of claim 47, wherein the first person is assigned a role that requires the first person to oversee the second activity assigned to the second person.

49. The system of claim 31, wherein the software performs processes for:
assigning a first task to a first person to test results of one or more tasks performed by selected persons for managing internal controls of the organization; and
generating a test interface that allows the first person to input data reflecting results of the first task.

50. The system of claim 31, wherein the software generates sign-off interfaces for persons associated with various business levels of the organization, each sign-off interface enabling a specified person to validate internal control related tasks performed by one or more persons overseen by the specified person.

51. The system of claim 50, wherein the software further generates a report based on the validation of the internal control related tasks by each specified person.

52. The system of claim 51, wherein the software performs processes that enable a person who is responsible for overseeing the entire organization to validate the report.

53. The system of claim 51, wherein the report includes information reflecting the organization's attempt to manage internal controls of the organization.

54. The system of claim 51, wherein the report includes information reflecting the organization's attempt to manage internal controls of the organization based on a governmental standard.

55. The system of claim 31, wherein the software generates dedicated interfaces for specified persons in the organization that enable these specified persons to validate the performance of one or more of the tasks performed by persons in the organization.

56. The system of claim 55, wherein the software generates a report including information representing the organization's attempt in managing internal controls of the organization, wherein the report is generated based on the validation by the specified persons in the organization.

57. The system of claim 31, wherein the workflows include tasks to be performed by persons associated with different business units of the organization.

58. The system of claim 31, wherein the workflows include tasks to be performed by persons associated with different organization units of the organization.

59. The system of claim 31, wherein the software provides dedicated user interfaces for:
scheduling, by a corporate level person in the organization, a corporate level workflow that includes activities for internal controls at a corporate level; and
assigning tasks to persons at the organization unit level to meet requirements of the scheduled corporate level workflow.

60. The system of claim 59, wherein the software further provides dedicated user interfaces for:
scheduling an organization unit level workflow based on the corporate level workflow; and
assigning tasks, by organization unit level persons, to meet requirements of the schedule-organization unit level workflow, wherein the organization unit workflow includes tasks that are unique to the organization unit level.

61. The system of claim 60, wherein the software further provides dedicated user interfaces for:
cascading the scheduling of subsequent workflows to lower organization level entities of the organization, wherein each scheduled subsequent workflow includes tasks that meet the requirements of the corporate level workflow and includes tasks that are unique to an organization level entity associated with the subsequent workflow.

62. A computer-readable medium including instructions for performing a method, when executed by a processor, for managing workflows in an organization, the method including:
assigning roles to persons in the organization, each role comprising one or more responsibilities for each person assigned to a role;
defining and scheduling workflows for managing internal controls of the organization, each workflow comprising a plurality of tasks to be performed by persons in the organization according to their assigned roles; and
communicating required tasks of each workflow to persons in the organization through respective dedicated interfaces for each person.

63. The computer-readable medium of claim 62, wherein communicating required tasks includes:
assigning a first activity to a first person and a second activity to a second person, each activity corresponding to a first workflow for managing internal controls; and
generating a dedicated interface for each of the first and second person based on the first and second activities, respectively.

64. The computer-readable medium of claim 63, wherein the first person is assigned a role that requires the first person to oversee the second activity assigned to the second person.

65. The computer-readable medium of claim 62, wherein the method further includes:
assigning a first task to a first person to test results of one or more tasks performed by selected persons for managing internal controls of the organization; and
generating a test interface that allows the first person to input data reflecting results of the first task.

66. The computer-readable medium of claim 62, wherein the method further includes:
generating sign-off interfaces for persons associated with various business levels of the organization, each sign-off interface enabling a specified person to validate internal control related tasks performed by one or more persons overseen by the specified person.

67. The computer-readable medium of claim 66, wherein generating sign-off interfaces includes:
generating a report based on the validation of the internal control related tasks by each specified person.

68. The computer-readable medium of claim 66, wherein the generating a report includes validating the report by a person who is responsible for overseeing the entire organization.

69. A system for managing workflows in an organization, including:
a display system for displaying content; and
a computer system configured to execute software to present a user interface on the display, the user interface including information reflecting one or more tasks to be performed by a person in the organization, the one or more tasks being included in a workflow for managing internal controls of the organization and are to be performed by the person based on an assigned role of the person in the organization.

70. The system of claim 69, wherein the person is assigned a role that requires the person to oversee a second task assigned to a second person.

71. The system of claim 70, wherein the one or more tasks include a testing task to test results of a task performed by selected persons for managing internal controls of the organization, and wherein the computer system executes software to generate a test user interface that allows the person to input data reflecting results of the testing task.

72. The system of claim 69, wherein the computer system executes software that generated sign-off interfaces for persons associated with various business levels of the organization, each sign-off interface enabling a specified person to validate internal control related tasks performed by one or more persons overseen by the specified person.

73. The system of claim 72, wherein the computer system executes software that generates a report based on the validation of the internal control related tasks by each specified person.
